(19) United States
(12) Patent Application Publication
(10) Pub. No.: US 2024/0365374 A1
(43) Pub. Date: Oct. 31, 2024

(54) TECHNIQUES FOR COORDINATED MEDIUM ACCESS FOR ULTRA-HIGH RELIABILITY

(71) Applicant: QUALCOMM Incorporated, San Diego, CA (US)

(72) Inventors: Abhishek Pramod PATIL, San Diego, CA (US); Abdel Karim AJAMI, San Diego, CA (US); Yanjun SUN, San Diego, CA (US); Gaurang NAIK, San Diego, CA (US); Sai Yiu Duncan HO, San Diego, CA (US); Alfred ASTERJADHI, San Diego, CA (US); George CHERIAN, San Diego, CA (US)

(21) Appl. No.: 18/510,397

(22) Filed: Nov. 15, 2023

Related U.S. Application Data
(60) Provisional application No. 63/499,191, filed on Apr. 28, 2023.

(51) Int. Cl. H04W 74/04; H04W 74/08

(52) U.S. Cl. CPC H04W 74/04; H04W 74/0816; H04W 74/0875

(57) ABSTRACT

This disclosure provides methods, components, devices and systems for techniques for coordinated medium access for ultra-high reliability. Some aspects more specifically relate to access point (AP)-to-AP coordination via, for example, one or more management frames. In some implementations, a wireless communication device may coordinate timing information with one or more other APs and may inform a set of stations (STAs) of the coordinated timing information, where a configured set of identifiers (IDs) may be used to differentiate which timing information pertains to which AP and inform how the set of STAs are expected to parse the coordinated timing information. Additionally, or alternatively, wireless communication devices may exchange one or more public action frames to facilitate AP-to-AP coordination, where such one or more public action frames may be specifically associated with providing information pertaining to coordinated medium access. Further, the described techniques may be applicable to multi-hop relay topologies.

### CROSS REFERENCE

The present Application for Patent claims the benefit of U.S. Provisional Patent Application No. 63/499,191 by PATIL et al., entitled “TECHNIQUES FOR COORDINATED MEDIUM ACCESS FOR ULTRA-HIGH RELIABILITY,” filed Apr. 28, 2023, assigned to the assignee hereof, and expressly incorporated by reference herein.

### TECHNICAL FIELD

This disclosure relates to wireless communication and, more specifically, to techniques for coordinated medium access for ultra-high reliability (UHR).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication performable at a first wireless communication device. The method may include obtaining first timing information pertaining to first communication periods that correspond to a set of access points (APs), transmitting, based on coordination with the first timing information, one or more management frames indicating at least second timing information pertaining to second communication periods that correspond to the first wireless communication device, the one or more management frames distinguishing the second communication periods from the first communication periods in accordance with a configured set of identifiers (IDs) that correspond to the first communication periods and the second communication periods, and communicating with one or more wireless stations (STAs) associated with the first wireless communication device during at least a subset of the second communication periods.

Another innovative aspect of the subject matter described in this disclosure can be implemented in a first wireless communication device. The first wireless communication device may include at least one memory and at least one processor communicatively coupled with the at least one memory (such as a processing system that includes one or more processors and one or more memories coupled with the one or more processors). The at least one processor may be operable to (or the processing system may be configured to) cause the first wireless communication device to obtain first timing information pertaining to first communication periods that correspond to a set of APs, transmit, based on coordination with the first timing information, one or more management frames indicating at least second timing information pertaining to second communication periods that correspond to the first wireless communication device, the one or more management frames distinguishing the second communication periods from the first communication periods in accordance with a configured set of IDs that correspond to the first communication periods and the second communication periods, and communicate with one or more wireless STAs associated with the first wireless communication device during at least a subset of the second communication periods.

Another innovative aspect of the subject matter described in this disclosure can be implemented in a first wireless communication device. The first wireless communication device may include means for obtaining first timing information pertaining to first communication periods that correspond to a set of APs, means for transmitting, based on coordination with the first timing information, one or more management frames indicating at least second timing information pertaining to second communication periods that correspond to the first wireless communication device, the one or more management frames distinguishing the second communication periods from the first communication periods in accordance with a configured set of IDs that correspond to the first communication periods and the second communication periods, and means for communicating with one or more wireless STAs associated with the first wireless communication device during at least a subset of the second communication periods.

Another innovative aspect of the subject matter described in this disclosure can be implemented in a non-transitory computer-readable medium storing code for wireless communication by a first wireless communication device. The code may include instructions executable by one or more processors to obtain first timing information pertaining to first communication periods that correspond to a set of APs, transmit, based on coordination with the first timing information, one or more management frames indicating at least second timing information pertaining to second communication periods that correspond to the first wireless communication device, the one or more management frames distinguishing the second communication periods from the first communication periods in accordance with a configured set of IDs that correspond to the first communication periods and the second communication periods, and communicate with one or more wireless STAs associated with the first wireless communication device during at least a subset of the second communication periods.

Some examples of the method, first wireless communication devices, and non-transitory computer-readable medium described herein may further include operations, features, means, or instructions for transmitting the first timing information within a first set of fields of a first information element of the one or more management frames, where each respective first ID field associated with the first set of fields includes a same ID of the configured set of IDs and transmitting the second timing information within a second set of fields of the first information element of the one or more management frames, where each respective second ID field associated with the second set of fields includes a unique ID of the configured set of IDs.

In some examples of the method, first wireless communication devices, and non-transitory computer-readable medium described herein, each respective first ID field associated with the first set of fields includes the same ID of the configured set of IDs to distinguish the first communication periods as corresponding to one or more overlapping basic service sets (OBSSs) and unique IDs for each respective second ID field associated with the second set of fields differentiates the second communication periods into one or more schedules of communication periods of the first wireless communication device.

In some examples of the method, first wireless communication devices, and non-transitory computer-readable medium described herein, the first wireless communication device may be a restricted target wake time (R-TWT) scheduling AP that may be announcing an R-TWT schedule with a restricted TWT schedule information subfield value set to three and the R-TWT scheduling AP may be to set a broadcast TWT ID subfield to a fixed value in a broadcast TWT field corresponding to the R-TWT schedule in accordance with announcing the R-TWT schedule with the restricted TWT schedule information subfield set to three.

Some examples of the method, first wireless communication devices, and non-transitory computer-readable medium described herein may further include operations, features, means, or instructions for transmitting a first subset of the first timing information within a first set of fields of a first information element of the one or more management frames, transmitting the second timing information within a second set of fields of the first information element of the one or more management frames, and transmitting a second subset of the first timing information within a third set of fields of a second information element of the one or more management frames.

In some examples of the method, first wireless communication devices, and non-transitory computer-readable medium described herein, the first subset of the first timing information pertains to a first subset of the first communication periods, the first subset of the first communication periods corresponding to a first set of APs associated with the first wireless communication device and the second subset of the first timing information pertains to a second subset of the first communication periods, the second subset of the first communication periods corresponding to a second set of APs non-collocated with the first wireless communication device.

In some examples of the method, first wireless communication devices, and non-transitory computer-readable medium described herein, each respective first ID field associated with the first set of fields and the second set of fields includes a unique ID of the configured set of IDs and each respective second ID field associated with the third set of fields includes respective identification information corresponding to a respective AP of a second set of APs non-collocated with the first wireless communication device.

In some examples of the method, first wireless communication devices, and non-transitory computer-readable medium described herein, the second information element may be an extension element and the respective identification information includes respective basic service set (BSS) ID (BSSID) identifying information.

Some examples of the method, first wireless communication devices, and non-transitory computer-readable medium described herein may further include operations, features, means, or instructions for transmitting the first timing information within a first set of fields of the one or more management frames, where a respective first schedule information subfield value of each of the first set of fields may be set to a same value in accordance with the first communication periods corresponding to the set of APs, the set of APs belonging to a same co-hosted BSSID set as the first wireless communication device and transmitting the second timing information within a second set of fields of the one or more management frames, where a respective second schedule information subfield value of each of the second set of fields may be set to a value from a set of multiple values in accordance with the second communication periods corresponding to the first wireless communication device.

In some examples of the method, first wireless communication devices, and non-transitory computer-readable medium described herein, the respective first schedule information subfield value may be a dedicated value of a schedule information field that indicates that a corresponding schedule of communication periods may be for one of the set of APs and the set of multiple values may be a set of values of the schedule information field that indicates that a corresponding schedule of communication periods may be for the first wireless communication device.

Another innovative aspect of the subject matter described in this disclosure can be implemented in a method for wireless communication performable at a first wireless communication device. The method may include communicating a public action frame in accordance with coordinated medium access involving the first wireless communication and at least a second wireless communication device and communicating with one or more wireless communication devices based on the coordinated medium access.

Another innovative aspect of the subject matter described in this disclosure can be implemented in a first wireless communication device. The first wireless communication device may include at least one memory and at least one processor communicatively coupled with the at least one memory (such as a processing system that includes one or more processors and one or more memories coupled with the one or more processors). The at least one processor may be operable to (or the processing system may be configured to) cause the first wireless communication device to communicate a public action frame in accordance with coordinated medium access involving the first wireless communication and at least a second wireless communication device and communicate with one or more wireless communication devices based on the coordinated medium access.

Another innovative aspect of the subject matter described in this disclosure can be implemented in a first wireless communication device. The first wireless communication device may include means for communicating a public action frame in accordance with coordinated medium access involving the first wireless communication and at least a second wireless communication device and means for communicating with one or more wireless communication devices based on the coordinated medium access.

Another innovative aspect of the subject matter described in this disclosure can be implemented in a non-transitory computer-readable medium storing code for wireless communication by a first wireless communication device. The code may include instructions executable by one or more processors to communicate a public action frame in accordance with coordinated medium access involving the first wireless communication and at least a second wireless communication device and communicate with one or more wireless communication devices based on the coordinated medium access.

In some examples of the method, first wireless communication devices, and non-transitory computer-readable medium described herein, the information included within the public action frame includes timing information associated with one or more communication periods and the coordinated medium access may be associated with the one or more communication periods.

Some examples of the method, first wireless communication devices, and non-transitory computer-readable medium described herein may further include operations, features, means, or instructions for transmitting a frame associated with a sharing of a transmission opportunity (TXOP) of the first wireless communication device with the second wireless communication device and receiving the public action frame from the second wireless communication device based on the sharing of the TXOP, where the public action frame indicates a return of a remainder of the TXOP to the first wireless communication device.

Some examples of the method, first wireless communication devices, and non-transitory computer-readable medium described herein may further include operations, features, means, or instructions for receiving a frame associated with a sharing of a TXOP of the second wireless communication device with the first wireless communication device, communicating with the one or more wireless communication devices during a portion of the TXOP, and transmitting the public action frame to the second wireless communication device, where the public action frame indicates a return of a remainder of the TXOP to the second wireless communication device.

Another innovative aspect of the subject matter described in this disclosure can be implemented in a method for wireless communication performable at a first wireless communication device. The method may include assigning an association identifier (AID) to an edge client, constructing a three-address frame format for one or more data frames to be transmitted toward the edge client or transmitted toward a root AP in accordance with including the AID in the one or more data frames transmitted toward the edge client, and transmitting the one or more data frames in accordance with the three-address frame format.

Another innovative aspect of the subject matter described in this disclosure can be implemented in a first wireless communication device. The first wireless communication device may include at least one memory and at least one processor communicatively coupled with the at least one memory (such as a processing system that includes one or more processors and one or more memories coupled with the one or more processors). The at least one processor may be operable to (or the processing system may be configured to) cause the first wireless communication device to assign an AID to an edge client, construct a three-address frame format for one or more data frames to be transmitted toward the edge client or transmitted toward a root AP in accordance with including the AID in the one or more data frames transmitted toward the edge client, and transmit the one or more data frames in accordance with the three-address frame format.

Another innovative aspect of the subject matter described in this disclosure can be implemented in a first wireless communication device. The first wireless communication device may include means for assigning an AID to an edge client, means for constructing a three-address frame format for one or more data frames to be transmitted toward the edge client or transmitted toward a root AP in accordance with including the AID in the one or more data frames transmitted toward the edge client, and means for transmitting the one or more data frames in accordance with the three-address frame format.

Another innovative aspect of the subject matter described in this disclosure can be implemented in a non-transitory computer-readable medium storing code for wireless communication by a first wireless communication device is described. The code may include instructions executable by one or more processors to assign an AID to an edge client, construct a three-address frame format for one or more data frames to be transmitted toward the edge client or transmitted toward a root AP in accordance with including the AID in the one or more data frames transmitted toward the edge client, and transmit the one or more data frames in accordance with the three-address frame format.

In some examples of the method, first wireless communication devices, and non-transitory computer-readable medium described herein, a data frame may be relayed to the edge client via one or more relay devices in accordance with a multi-hop relay path, a receiver address (RA) and a transmitter address (TA) change at each hop of the multi-hop relay path, and a relay device immediately upstream of the edge client determines a final RA in accordance with the AID.

In some examples of the method, first wireless communication devices, and non-transitory computer-readable medium described herein, the AID may be included in an A-Control field of the one or more data frames.

Another innovative aspect of the subject matter described in this disclosure can be implemented in a method for wireless communication performable at a first wireless communication device. The method may include obtaining, based on coordination with first timing information pertaining to first communication periods that correspond to a set of APs, one or more management frames indicating at least second timing information pertaining to second communication periods that correspond to the second wireless communication device, the one or more management frames distinguishing the second communication periods from the first communication periods in accordance with a configured set of IDs that correspond to the first communication periods and the second communication periods and communicating with the second wireless communication device or a third wireless communication device in accordance with the second communication periods.

Another innovative aspect of the subject matter described in this disclosure can be implemented in a first wireless communication device. The first wireless communication device may include at least one memory and at least one processor communicatively coupled with the at least one memory (such as a processing system that includes one or more processors and one or more memories coupled with the one or more processors). The at least one processor may be operable to (or the processing system may be configured to) cause the first wireless communication device to obtaining, base at least in part on coordination with first timing information pertaining to first communication periods that correspond to a set of APs, one or more management frames indicating at least second timing information pertaining to second communication periods that correspond to the second wireless communication device, the one or more management frames distinguishing the second communication periods from the first communication periods in accordance with a configured set of IDs that correspond to the first communication periods and the second communication periods and communicate with the second wireless communication device or a third wireless communication device in accordance with the second communication periods.

Another innovative aspect of the subject matter described in this disclosure can be implemented in a first wireless communication device. The first wireless communication device may include means for obtaining, based on coordination with first timing information pertaining to first communication periods that correspond to a set of APs, one or more management frames indicating at least second timing information pertaining to second communication periods that correspond to the second wireless communication device, the one or more management frames distinguishing the second communication periods from the first communication periods in accordance with a configured set of IDs that correspond to the first communication periods and the second communication periods and means for communicating with the second wireless communication device or a third wireless communication device in accordance with the second communication periods.

Another innovative aspect of the subject matter described in this disclosure can be implemented in a non-transitory computer-readable medium storing code for wireless communication by a first wireless communication device. The code may include instructions executable by one or more processors to obtaining, base at least in part on coordination with first timing information pertaining to first communication periods that correspond to a set of APs, one or more management frames indicating at least second timing information pertaining to second communication periods that correspond to the second wireless communication device, the one or more management frames distinguishing the second communication periods from the first communication periods in accordance with a configured set of IDs that correspond to the first communication periods and the second communication periods and communicate with the second wireless communication device or a third wireless communication device in accordance with the second communication periods.

Some examples of the method, first wireless communication devices, and non-transitory computer-readable medium described herein may further include operations, features, means, or instructions for obtaining the first timing information pertaining to the first communication periods, where the set of APs to which the first communication periods correspond may be OBSS APs and respecting a set of rules associated with the first communication periods.

In some examples of the method, first wireless communication devices, and non-transitory computer-readable medium described herein, respecting the first communication periods may include operations, features, means, or instructions for terminating a transmission opportunity of the first wireless communication period prior to a start of each of the first communication periods and following a set of channel access rules within each of the first communication periods.

Some examples of the method, first wireless communication devices, and non-transitory computer-readable medium described herein may further include operations, features, means, or instructions for obtaining the first timing information within a first set of fields of a first information element of the one or more management frames, where each respective first ID field associated with the first set of fields includes a same ID of the configured set of IDs and obtaining the second timing information within a second set of fields of the first information element of the one or more management frames, where each respective second ID field associated with the second set of fields includes a unique ID of the configured set of IDs.

In some examples of the method, first wireless communication devices, and non-transitory computer-readable medium described herein, each respective first ID field associated with the first set of fields includes the same ID of the configured set of IDs to distinguish the first communication periods as corresponding to one or more OBSSs and unique IDs for each respective second ID field associated with the second set of fields differentiates the second communication periods into one or more schedules of communication periods of the second wireless communication device.

Some examples of the method, first wireless communication devices, and non-transitory computer-readable medium described herein may further include operations, features, means, or instructions for obtaining a first subset of the first timing information within a first set of fields of a first information element of the one or more management frames, obtaining the second timing information within a second set of fields of the first information element of the one or more management frames, and obtaining a second subset of the first timing information within a third set of fields of a second information element of the one or more management frames.

In some examples of the method, first wireless communication devices, and non-transitory computer-readable medium described herein, the first subset of the first timing information pertains to a first subset of the first communication periods, the first subset of the first communication periods corresponding to a first set of APs associated with the second wireless communication device and the second subset of the first timing information pertains to a second subset of the first communication periods, the second subset of the first communication periods corresponding to a second set of APs non-collocated with the second wireless communication device.

In some examples of the method, first wireless communication devices, and non-transitory computer-readable medium described herein, each respective first ID field associated with the first set of fields and the second set of fields includes a unique ID of the configured set of IDs and each respective second ID field associated with the third set of fields includes a respective identification information corresponding to a respective AP of a second set of APs non-collocated with the second wireless communication device.

In some examples of the method, first wireless communication devices, and non-transitory computer-readable medium described herein, the second information element may be an extension element and the respective identification information includes respective BSSID identifying information.

Some examples of the method, first wireless communication devices, and non-transitory computer-readable medium described herein may further include operations, features, means, or instructions for obtaining the first timing information within a first set of fields of the one or more management frames, where a respective first schedule information subfield value of each of the first set of fields may be set to a same value in accordance with the first communication periods corresponding to the set of APs (such as matching to a corresponding AP in the set of APs), the set of APs belonging to a same co-hosted BSSID set as the second wireless communication device and obtaining the second timing information within a second set of fields of the one or more management frames, where a respective second schedule information subfield value of each of the second set of fields may be set to a value from a set of multiple values in accordance with the second communication periods corresponding to the second wireless communication device.

In some examples of the method, first wireless communication devices, and non-transitory computer-readable medium described herein, the respective first schedule information subfield value may be a dedicated value of a schedule information field that indicates that a corresponding schedule of communication periods may be for one of the set of APs associated with the second wireless communication device and the set of multiple values may be a set of values of the schedule information field that indicates that a corresponding schedule of communication periods may be for the second wireless communication device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a wireless communication system that supports techniques for coordinated medium access for ultra-high reliability according to some aspects of the present disclosure.

FIG. 3 shows an example of a frame format that supports techniques for coordinated medium access for ultra-high reliability according to some aspects of the present disclosure.

FIG. 4 shows an example of a wireless communication system that supports techniques for coordinated medium access for ultra-high reliability according to some aspects of the present disclosure.

FIGS. 5 and 6 show block diagrams of example wireless communication devices that support techniques for coordinated medium access for ultra-high reliability according to some aspects of the present disclosure.

FIGS. 7-12 show flowcharts illustrating example processes that support techniques for coordinated medium access for ultra-high reliability according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to coordinated medium access between wireless communication devices. Some aspects more specifically relate to coordinated medium access between access points (APs), where such coordinated medium access may include various types of coordinated medium access as described herein. In some implementations, an AP may transmit one or more frames (such as one or more management or advertising frames) indicating information pertaining to the coordinated medium access and may further include identifiers (IDs) of a configured set of IDs to differentiate between potential medium access opportunities for STAs associated with the AP and other medium access opportunities that STAs associated with the AP may be expected to avoid. For example, an AP may indicate first timing information pertaining to first communication periods corresponding to other APs and second timing information pertaining to second communication periods corresponding to the AP, along with one or more IDs from the configured set of IDs, to enable receiving STAs (and receiving APs) to identify which communication periods are to be used or protected by each of multiple neighboring APs. As described herein, such a configured set of IDs may refer to broadcast target wake time (TWT) IDs or restricted TWT (which may be understood as or referred to as r-TWT, R-TWT, or rTWT) scheduling information subfield values, among other examples. Further, in some implementations, APs may exchange one or more public action frames to facilitate coordinated medium access. Such public action frames may include timing information (such as TWT schedule information) or may indicate other information related to coordinated medium access, such as a return of a shared transmission opportunity (TXOP) to the original TXOP owner. Further, in some implementations, wireless communication devices may implement the described coordinated medium access techniques along a multi-hop relay path and may support one or more mechanisms for using a 3-address format for any relayed frames.

Particular aspects of the subject matter described in this disclosure can be implemented to realize one or more of the following potential advantages. In some implementations, by enabling and further defining mechanisms associated with coordinated medium access, various wireless communication devices within a system may achieve more efficient medium utilization. For example, coordinated medium access may enable higher priority traffic flows to have predictable medium access opportunities, which may result in greater throughput, lower latency, and improved user experiences in various applications and deployment scenarios. Further, by using public action frames to facilitate some aspects of AP-to-AP coordination, unassociated APs may still exchange coordination information with each other in a low overhead and timely manner without causing system ambiguity. Further, by extending the described techniques to multi-hop relay topologies and using a 3-address format for relayed frames, wireless communication devices may relay data in a more timely and predictable manner and may experience lower processing costs (as compared to when other address formats are used along a multi-hop relay path). As such, the described techniques may be implemented to realize greater throughput, higher data rates, greater coordination, greater spectral efficiency, and improved user experience, among other benefits as described herein.

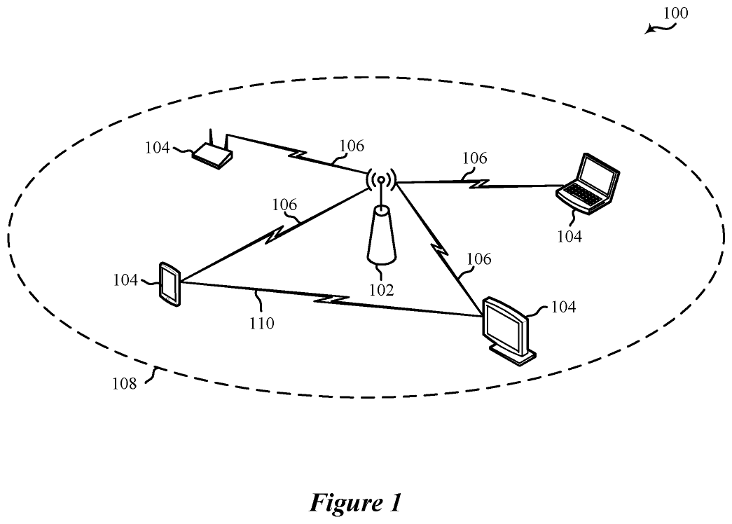

FIG. 1 shows a pictorial diagram of an example wireless communication network 100. According to some aspects, the wireless communication network 100 can be an example of a wireless local area network (WLAN), such as a Wi-Fi network. For example, the wireless communication network 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The wireless communication network 100 may include numerous wireless communication devices such as a wireless AP 102 and multiple wireless STAs1. While only one AP 102 is shown in FIG. 1, the wireless communication network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP 102 serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (such as TVs (including smart TVs), computer monitors, navigation systems, among others), music or other audio or stereo devices, remote control devices (“remotes”), printers, kitchen appliances (including smart refrigerators) or other household appliances, key fobs (such as for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. An extended network station associated with the wireless communication network 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger wireless network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

Some APs 102 and STAs 104 may implement spatial reuse techniques. For example, APs 102 and STAs 104 configured for communications using IEEE 802.11ax or 802.11be may be configured with a BSS color. APs 102 associated with different BSSs may be associated with different BSS colors. A BSS color is a numerical identifier of an AP's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first received signal strength indication (RSSI) detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs 102 and STAs 104 may implement techniques for spatial reuse that involve participation in a coordinated communication scheme. According to such techniques, an AP 102 may contend for access to a wireless medium to obtain control of the medium for a TXOP. The AP 102 that wins the contention (hereinafter also referred to as a “sharing AP”) may select one or more other APs 102 (hereinafter also referred to as “shared APs”) to share resources of the TXOP. The sharing and shared APs 102 may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP, The sharing AP 102 may allocate the time or frequency segments to itself or to one or more of the shared APs 102. For example, each shared AP 102 may utilize a partial TXOP assigned by the sharing AP 102 for its uplink or downlink communications with its associated STAs 104.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs 102 and their respective BSSs, subject to appropriate power control and link adaptation. For example, the sharing AP 102 may limit the transmit powers of the selected shared APs 102 such that interference from the selected APs 102 does not prevent STAs 104 associated with the TXOP owner from successfully decoding packets transmitted by the sharing AP 102. Such techniques may be used to reduce latency because the other APs 102 may not need to wait to win contention for a TXOP to be able to transmit and receive data according to conventional CSMA/CA or EDCA techniques. Additionally, by enabling a group of APs 102 associated with different BSSs to participate in a coordinated AP transmission session, during which the group of APs 102 may share at least a portion of a single TXOP obtained by any one of the participating APs 102, such techniques may increase throughput across the BSSs associated with the participating APs 102 and also may achieve improvements in throughput fairness. Furthermore, with appropriate selection of the shared APs 102 and the scheduling of their respective time or frequency resources, medium utilization may be maximized or otherwise increased while packet loss resulting from OBSS interference is minimized or otherwise reduced. Various implementations may achieve these and other advantages without requiring that the sharing AP 102 or the shared APs 102 be aware of the STAs 104 associated with other BSSs, without requiring a preassigned or dedicated master AP 102 or preassigned groups of APs 102, and without requiring backhaul coordination between the APs 102 participating in the TXOP.

In some examples in which the signal strengths or levels of interference associated with the selected APs 102 are relatively low (such as less than a given value), or when the decoding error rates of the selected APs 102 are relatively low (such as less than a threshold), the start times of the communications among the different BSSs may be synchronous. Conversely, when the signal strengths or levels of interference associated with the selected APs 102 are relatively high (such as greater than the given value), or when the decoding error rates of the selected APs 102 are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP 102 (or its associated STAs 104) to decode the preamble of the wireless packet and obtain the BSS color value carried in the wireless packet to determine whether the wireless packet is an intra-BSS packet or an OBSS packet. In this manner, each of the participating APs 102 and their associated STAs 104 may be able to receive and decode intra-BSS packets in the presence of OBSS interference.

In some implementations, the sharing AP 102 may perform polling of a set of un-managed or non-co-managed APs 102 that support coordinated reuse to identify candidates for future spatial reuse opportunities. For example, the sharing AP 102 may transmit one or more spatial reuse poll frames as part of determining one or more spatial reuse criteria and selecting one or more other APs 102 to be shared APs 102. According to the polling, the sharing AP 102 may receive responses from one or more of the polled APs 102. In some specific examples, the sharing AP 102 may transmit a coordinated AP TXOP indication (CTI) frame to other APs 102 that indicates time and frequency of resources of the TXOP that can be shared. The sharing AP 102 may select one or more candidate APs 102 upon receiving a coordinated AP TXOP request (CTR) frame from a respective candidate AP 102 that indicates a desire by the respective AP 102 to participate in the TXOP. The poll responses or CTR frames may include a power indication, for example, an RX power or RSSI measured by the respective AP 102. In some other examples, the sharing AP 102 may directly measure potential interference of a service supported (such as UL transmission) at one or more APs 102, and select the shared APs 102 based on the measured potential interference. The sharing AP 102 generally selects the APs 102 to participate in coordinated spatial reuse such that it still protects its own transmissions (which may be referred to as primary transmissions) to and from the STAs 104 in its BSS. The selected APs 102 may then be allocated resources during the TXOP as described above.

In some implementations, multiple APs 102 may transmit to one or more STAs 104 at a time utilizing a distributed MU-MIMO scheme. Examples of such distributed MU-MIMO transmissions include coordinated beamforming (CBF) and joint transmission (JT). With CBF, signals (such as data streams) for a given STA 104 may be transmitted by only a single AP 102. However, the coverage areas of neighboring APs 102 may overlap, and signals transmitted by a given AP 102 may reach the STAs 104 in OBSSs associated with neighboring APs 102 as OBSS signals. CBF allows multiple neighboring APs 102 to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs 104 in OBSSs such that any signals received at an OBSS STA 104 are of sufficiently low power to limit the interference at the STA 104. To accomplish this, an inter-BSS coordination set may be defined between the neighboring APs 102, which contains identifiers of all APs 102 and STAs 104 participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

Some wireless communication devices (including both APs 102 and STAs 104) are capable of multi-link operation (MLO). In some implementations, MLO supports establishing multiple different communication links (such as a first link on the 2.4 GHz band, a second link on the 5 GHz band, and the third link on the 6 GHz band) between the STA 104 and the AP 102. Each communication link may support one or more sets of channels or logical entities. In some examples, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs 102 each configured to communicate on a respective communication link with a respective one of multiple STAs 104 of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA 104 is simultaneously transmitted across multiple communication links in parallel to maximize the utilization of available resources to achieve higher throughput. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some implementations, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

As described herein, any one or more of the wireless communication devices illustrated by and described with reference to FIG. 1 may implement any one or more coordinated medium access schemes or coordinated medium access techniques. For example, wireless communication devices may use a configured set of IDs, public action frames, and 3-address frame formats to facilitate coordinated medium access and enable flexible decisions associated with one or both of lower signaling overhead and reduced device processing.

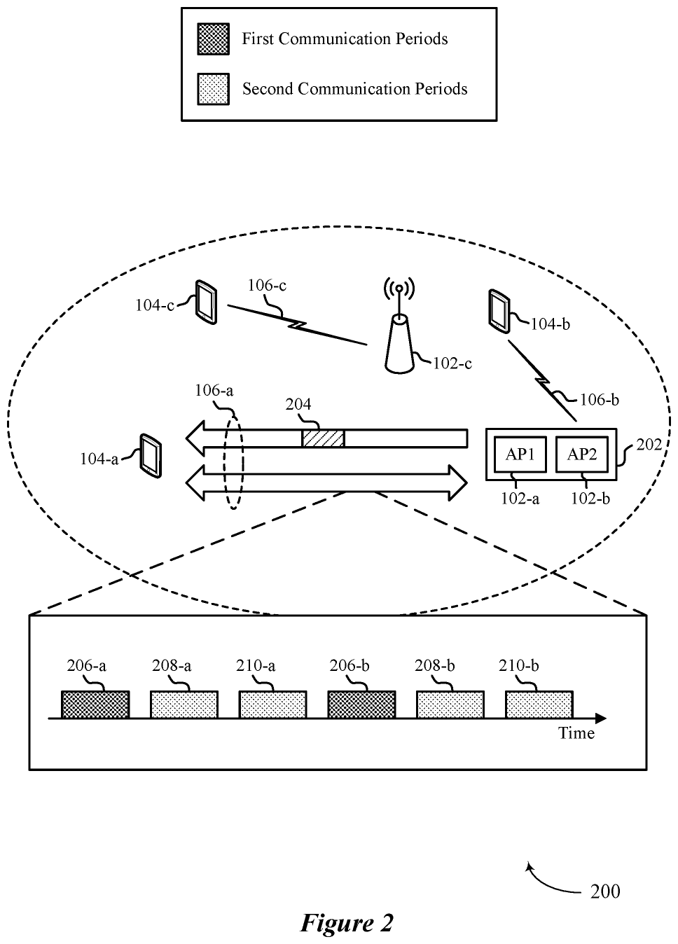

FIG. 2 shows an example of a wireless communication system 200 that supports techniques for coordinated medium access for ultra-high reliability according to some aspects of the present disclosure. The wireless communication system 200 may implement or be implemented to realize aspects of the wireless communication network 100. For example, the wireless communication system 200 illustrates communication between various wireless communication devices, including a collocated AP set including an AP 102-a and an AP 102-b (such that the AP 102-a and the AP 102-b may be understood as virtual APs (VAPs)), a non-collocated AP 102-c, a wireless STA 104-a, a wireless STA 104-b, and a wireless STA 104-c. As described herein, any of such APs or STAs may be referred to or understood as a wireless communication device.

The AP 102-a of the collocated AP set 202 may communicate with the wireless STA 104-a via a communication link 106-a, the AP 102-b of the collocated AP set 202 may communicate with the wireless STA 104-b via a communication link 106-b, and the non-collocated AP 102-c may communicate with the wireless STA 104-c via a communication link 106-c. As described herein, communicating with a wireless communication device may include transmitting one or more messages or frames to the wireless communication device or receiving one or more messages or frames from the wireless communication device, or both.

In some systems, such as in ultra-high reliability (UHR) systems, wireless communication devices may support one or more of several aspects or features involving medium access coordination amongst APs 102 and STAs 104, including amongst APs 102 and STAs 104 belonging to different BSSs. Such medium access coordination may include coordinated TDMA (C-TDMA), coordinated scheduling request (C-SR), or coordinated OFDMA (C-OFDMA) between neighboring APs 102, TWT (such as restricted TWT (R-TWT)) coordination between neighboring OBSSs, or multi-primary channel access techniques, among other examples.

In some aspects, wireless communication devices may employ an R-TWT framework to aid low-latency flows (such as to prioritize low-latency flows over non-low-latency flows). In such aspects, the wireless communication devices (such as any combination of APs 102 and STAs 104) may negotiate timing aspects related to R-TWT, including time epochs or service periods (SPs) associated with R-TWT. R-TWT may be a variant of broadcast TWT (B-TWT). During an R-TWT, in-BSS STAs 104 (that support R-TWT) may terminate (such as in accordance with a system expectation or constraint) a TXOP before a start of an R-TWT SP. Additionally, or alternatively, one or more wireless communication devices may restart one or more counters associated with channel access (contention) at a beginning of an R-TWT SP.

In some aspects, some coordinated medium access mechanisms may be employed in or extended to a multi-hop relay topology. For example, if two wireless communication devices communicate with each other via multiple (or at least one) relay devices, the wireless communication devices and the multiple (or at least one) relay devices may support TXOP sharing (such as via a C-TDMA mechanism) or an establishment of sequential (and coordinated) back-to-back (such as end-to-end) R-TWTs (such as R-TWT SPs) to aid in low-latency delivery of low-latency flows over multiple hops.

UHR capable devices may leverage or extend some coordinated access mechanisms to enable some of the such medium access coordination. For example, one or more wireless communication devices may use a multi-user (MU)-request to send (RTS) TXOP sharing (TXS) framework or R-TWT coordination between collocated APs 102 (APs 102 in a multiple BSSID set, such as the collocated AP set 202). Further, some wireless communication devices may support one or more rules for coordinating R-TWT amongst APs 102 belonging to a multiple BSSID set. For example, some wireless communication devices may support or define (such as in accordance with a standard or network configuration) a special value (such as 3) to indicate a schedule (such as an R-TWT SP schedule) for another AP 102 in the set. Such a special value may be carried in a schedule information subfield, such as a Restricted TWT Schedule Info (RTSI) subfield, of a TWT information element (IE) (which may be alternatively referred to as a TWT element). As described herein, an RTSI subfield may be an example of a schedule information subfield, and may be included in any field or subfield of any frame, such as a management frame (such as a beacon frame or a probe response frame, among other examples).

In some systems, however, such rules may be underspecified and ambiguous. For example, some coordination rules may fail to provide definiteness or general applicability to various types of scenarios that will be desired in systems featuring greater throughput capacity, denser deployments, more efficient and lower latency medium access, and the like. In an example, some coordination rules may be deficient as a result of a lack of clarity associated with what information is to be included within the TWT element carried in a management frame (such as a beacon frame or a probe response frame) of a transmitted BSSID or within a nontransmitted BSSID profile. In addition, coordination rules for co-hosted BSSID sets are unclearly defined or provided, which may result in ambiguity in some deployment scenarios. Moreover, without any or sufficient rules for coordination, one or more STAs 104 belonging to an OBSS may step on (such as perform a transmission during) an R-TWT, thus limiting the benefits of any other AP coordination.

In some implementations of the present disclosure, various wireless communication devices may support one or more configuration- or signaling-based mechanisms according to which such wireless communication devices may address various aspects related to medium access coordination. More specifically, aspects of the present disclosure provide several options or several different mechanisms, which may be leveraged independently or in a combined manner, for coordinated medium access (including coordinating B-TWTs and/or R-TWTs) amongst APs 102 (and their associated STAs 104) belonging to a multiple BSSID set and a co-hosted BSSID set, as well as amongst non-collocated APs 102.

In other words, the described techniques provide various mechanisms or aspects related to AP-to-AP coordination, including coordinated medium access (which may be referred to as CMA) amongst (such as between) neighboring APs 102 (via, using, or otherwise in accordance with R-TWT). Such mechanisms or aspects for coordinated medium access and coordinated R-TWT (c-R-TWT) may include advertisement of OBSS schedules to in-BSS STAs 104, channel access within SPs, group formation, signaling amongst APs 102, mechanisms associated with critical updates, aspects and mechanisms associated with beacon offloading, and the like.

An AP 102 (such as the AP 102-a) may transmit a frame (such as a frame 204) including timing information pertaining to one or more TWT schedules provided by the AP 102 as well as any one or more TWT schedules provided by one or more other APs 102 (such as the AP 102-b or the AP 102-c, or both). In some aspects, an AP 102 may transmit information pertaining to one or multiple broadcast TWT schedules, each broadcast TWT schedule being identified by an ID. The ID may be carried in a broadcast TWT ID field. In some implementations, the broadcast TWT ID field may be, carry, or include 5 bits, such that there may be 32 possible values that can be indicated by the broadcast TWT ID field. In some implementations, a value 0 may have a special or reserved meaning, such that there may effectively be 31 available values that can be indicated by the broadcast TWT ID field to identify a TWT schedule. Of the 31 available values, a wireless communication device may select one value to include in a broadcast TWT ID field to identify a corresponding TWT schedule, but some systems may lack a definite or clear mechanism according to which the wireless communication device is expected to make that selection, which may lead to ambiguity.

In particular, some systems may lack a mechanism for determining which value to include in a broadcast TWT ID field that is useful across various deployment scenarios. For example, some mechanisms may lack scalability as coordinating APs 102 may include OBSS APs from a same multiple BSSID (which may be referred to as an MBSSID) set or a same co-hosted set (such as the AP 102-b relative to the AP 102-a) as well as non-collocated APs 102 (such as the non-collocated AP 102-c). If an AP 102 were to use a unique broadcast TWT ID value for each schedule that the AP 102 announces (such as for its own schedule and for any schedules of other APs 102), the number of R-TWT or B-TWT schedules it can setup for its own may be significantly limited. For example, in a set of 16 BSSIDs, each AP 102 may be able to use an upper limit of 2 IDs. Further, signaling mechanisms associated with allocating various IDs of the 31 available IDs to different APs may involve coordination of broadcast TWT IDs amongst collocated and non-collocated APs 102, which may introduce additional signaling overhead and impart greater processing costs at various wireless communication devices.

Accordingly, in some implementations, one or more wireless communication devices may select (such as reserve) a value (such as a value 31, which may correspond to all 1 bits in the broadcast TWT ID field) to indicate a B-TWT of an OBSS AP 102 (where such an OBSS AP 102 may include one or more MBSSID, co-hosted, or non-collocated APs 102). For example, the AP 102-a may transmit the frame 204 and the frame 204 may include one or more first broadcast TWT ID fields corresponding to one or more first TWT schedules of the AP 102-a, one or more second broadcast TWT ID fields corresponding to one or more second TWT schedules of the AP 102-b, and one or more third broadcast TWT ID fields corresponding to one or more third TWT schedules of the AP 102-c. In such examples, the one or more first broadcast TWT ID fields may include values selected from a set of available values (such as a set of values 1-30, which may be understood as a subset of a set of configured IDs, with 1-30 being a subset of 1-31; likewise, the set of available values may be understood as values within a range greater than 0 and less than 31) and both the one or more second broadcast TWT ID fields and the one or more third broadcast TWT ID fields may include the selected (reserved) value (such as a value 31) to indicate that corresponding TWT schedules are of an OBSS AP 102 (such that the AP 102-b and the AP 102-c are understood as OBSS APs 102).

In some other implementations, APs 102 in a MBSSID set or a co-hosted set may share a same ID space (such as a same set of available values for a broadcast TWT ID field). In such implementations, each AP 102 in the MBSSID set or the co-hosted set may receive or otherwise have an upper limit quantity of IDs that limit a quantity of broadcast or restricted TWTs that AP 102 can setup. For example, in a set including 16 APs 102 (such as 16 BSSIDs) and in scenarios in which there are approximately 31 available values, each AP 102 in the set may receive or otherwise have an upper limit of 2 IDs. In such implementations, a transmitting AP 102 (such as the AP 102-a) may carry one or more R-TWT parameter sets for other APs 102 (such as non-collocated APs 102, including the AP 102-c) in a separate IE (such as a TWT Extension IE) along with information that identifies each of the other APs 102, such as an AP ID. Such information that identifies an AP 102 may include or be associated with identification via a BSS color, identification via a quantity n of the least significant bits (LSBs), which may be understood as n-LSBs, of a BSSID, and the like. For example, the AP 102-a may transmit the frame 204 and the frame 204 may include one or more first broadcast TWT ID fields corresponding to one or more first TWT schedules of the AP 102-a and one or more second broadcast TWT ID fields corresponding to one or more second TWT schedules of the AP 102-b, where the one or more first broadcast TWT ID fields and the one or more second broadcast TWT ID fields may include values selected from a set of available values (such as a set of values 1-31), and the AP 102-a may include information associated with TWT schedules of the non-collocated AP 102-c in a separate IE of the frame 204 (or in a separate, such as follow-up, frame).

Additionally, or alternatively, each if not all of the APs 102 in the multiple BSSID set may manage to use unique IDs that are not used by other BSSIDs. Additionally, or alternatively, some wireless communication devices may provide an additional identifier for a broadcast/restricted TWT parameter set, where such an additional identifier can be an extended element carrying the BSSID identifying information (such as a MAC address among other examples of BSSID identifying information).

In accordance with the techniques described herein, one or more wireless communication devices may additionally, or alternatively, support advertisement within an MBSSID or co-hosted set. For coordination in an MBSSID set, system efficiency may benefit from a STA 104 associated with any BSS knowing or otherwise having information about the R-TWT(s) belonging to its associated BSS and every other BSS in the set. As such, the STA 104 can respect (such as honor and avoid violating) one or more R-TWT rules (such as a rule associated with a termination of a TXOP before a start of an SP and channel access rules at the start of the SP). In some systems, however, some wireless communication devices may experience ambiguity resulting from an under-specification of expected behavior associated with informing STAs 104 of other relevant R-TWT(s) that the STAs 104 are expected to respect and a lack of rules generally applicable for a co-hosted BSSID set.

Accordingly, the described techniques may be implemented by one or multiple wireless communication devices to resolve such ambiguity in both the context of a co-hosted BSSID set and a multiple BSSID set. In some implementations, for a co-hosted BSSID set, management frames (such as beacon frames or probe response frames, among other examples) from each AP 102 may carry R-TWT parameter set(s) of that AP 102 (with an RTSI subfield value set to 0, 1, or 2) and R-TWT parameter set(s) for other APs 102 in the same co-hosted BSSID set (with an RTSI subfield value set to 3). In such implementations, APs 102 and non-APs (such as STAs 104) may extend one or more procedures and/or processing operations to generate and/or parse such management frames (such as without defining a new procedure or processing operation) while more completely sharing or obtaining timing information that pertains to various APs 102 (which may facilitate or realize coordinated medium access).

In some other implementations, for a co-hosted BSSID set, management frames (such as beacon frames or probe response frames, among other examples) from each AP 102 may exclusively (such as only) carry the R-TWT parameter set(s) of that AP 102 (with an RTSI subfield value set to 0, 1, or 2). In such implementations, a non-AP (such as a STA 104) may process (or may be expected to process) beacons of all APs 102 within the co-hosted BSSID set to determine (such as identify) and respect R-TWT schedules (including R-TWT SPs) of other APs 102. For example, in such implementations, a non-AP may (constantly or periodically) monitor beacons of all APs 102 to track any changes to the R-TWT schedules (in accordance with critical updates procedures). In some aspects, one or multiple wireless communication devices may elect to implement such a mechanism in accordance with an election to prioritize smaller management frames (such as smaller beacon frames or smaller probe response frames, among other examples) at the potential expense of greater processing overhead at the non-APs (which, in deployments associated with a relatively small quantity of APs 102, may be negligible or otherwise worth the benefit of smaller management frames).

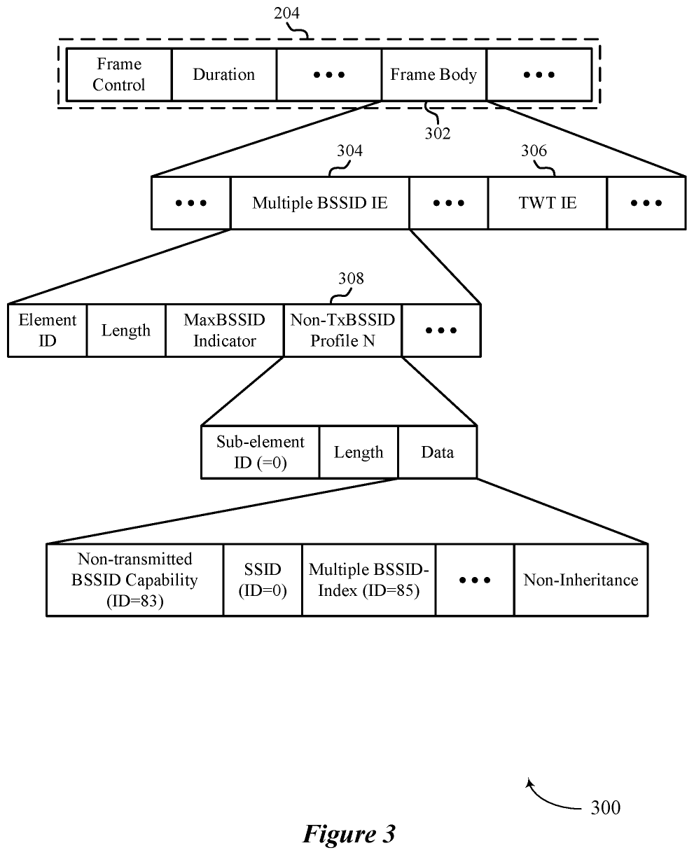

In some implementations, for a multiple BSSID set, a management frame of a transmitted BSSID may carry a multiple BSSID IE (which may be alternatively referred to as a multiple BSSID element) and a TWT IE (a TWT element), and the TWT IE carried outside of the multiple BSSID IE may include one or more R-TWT parameter sets for the transmitted BSSID (with RTSI subfield values set to 0, 1, or 2) and R-TWT parameter sets corresponding to all nontransmitted BSSID(s) in that multiple BSSID set that are currently active (with RTSI subfield values set to 3). The multiple BSSID IE, as illustrated by and described in more detail with reference to FIG. 3, may include one or more nontransmitted BSSID profiles, each nontransmitted BSSID profile including a TWT IE. The TWT IE carried within a nontransmitted BSSID profile (contained within the multiple BSSID element) may include R-TWT parameters exclusively (such as only) for that particular nontransmitted BSSID (with an RTSI subfield value set to 0, 1, or 2).

In such implementations, a STA 104 receiving the management frame (such as a beacon frame and/or a probe response frame) of the transmitted BSSID may parse the management frame based on whether the STA 104 is associated with the transmitted BSSID. If the STA 104 is associated with the transmitted BSSID, for example, the STA 104 may (only) parse the TWT IE outside of the multiple BSSID IE and honor any R-TWT parameter sets corresponding to a non-zero RTSI subfield value. Such an associated STA 104 may subscribe to an R-TWT schedule that has an RTSI subfield value of 0 or 1. If the STA 104 is R-TWT capable and is associated with a nontransmitted BSSID, the STA 104 may parse the TWT information carried in the TWT IE outside of the multiple BSSID IE, honor all R-TWT parameter sets corresponding to a non-zero RTSI subfield value, and parse the TWT IE within a nontransmitted BSSID profile of its associated (non-transmitting) AP 102. The STA 104 may subscribe to an R-TWT schedule (advertised in the parsed nontransmitted BSSID profile of the AP 102 to which the STA 104 is associated) that has an RTSI subfield value of 0 or 1. Further, some TWT schedules (such as R-TWT schedules indicated by an R-TWT parameter set) having RTSI subfield values set to 3 and carried in the TWT IE contained in the transmitted BSSID's management frame may match the R-TWT parameter set(s) of the nontransmitted BSSID with RTSI subfield value(s) set to 1 or 2. Likewise, the other R-TWT schedules in the TWT IE of the transmitted BSSID may match R-TWT schedules of other nontransmitted BSSIDs in the set (such as the multiple BSSID set or the co-hosted BSSID set).

For example, for a client that is not associated with a transmitted BSSID, the client may parse the TWT IE carried outside the MBSSID IE to identify all the R-TWT SPs, and compare the R-TWT schedules advertised in its corresponding nontransmitted BSSID profile to identify the R-TWT schedules that apply to its profile. The client may then join a TWT schedule based on the value carried in the RTSI subfield (0 or 1) and honor (such as respect) any TWT schedules associated with RTSI subfield values of 2. In addition, the client may also honor the rest of the R-TWT schedules indicated in the TWT IE outside the MBSSID IE (such as the TWT schedules belonging to the transmitted BSSID or other nontransmitted BSSIDs).

Further, in such implementations, inheritance may be applied at the R-TWT parameter set level, as opposed to at the element level. For example, the STA 104 may apply inheritance on an R-TWT parameter set basis because the TWT element carried outside of the multiple BSSID IE may include R-TWT parameter set fields associated with various different APs 102 (as opposed to R-TWT parameter set fields exclusively corresponding to the transmitting AP 102).

In some implementations, for a multiple BSSID set, a beacon and a probe response frame (or any other management frame) of a transmitted BSSID may carry a multiple BSSID IE and a TWT IE, and the TWT IE carried outside of the multiple BSSID IE may include R-TWT parameter sets exclusively for the transmitted BSSID (with an RTSI subfield value set to 0, 1, or 2). Further, in such implementations, a TWT IE carried within a nontransmitted BSSID profile (contained within the multiple BSSID element) may include R-TWT parameters exclusively for that particular nontransmitted BSSID (with an RTSI subfield value set to 0, 1, or 2).

In such implementations, a STA 104 receiving the management frame (such as the beacon frame or the probe response frame) of the transmitted BSSID may parse the management frame based on whether the STA 104 is associated with the transmitted BSSID. If the STA 104 is associated with the transmitted BSSID, for example, the STA 104 may parse the TWT IE outside of the multiple BSSID IE and the TWT IE(s) carried within each nontransmitted BSSID profile (included within the multiple BSSID IE). As such, the STA 104 may obtain the TWT schedule information for its associated AP 102 as well as other APs 102 and may honor the TWT schedules (such as the R-TWT schedules) belonging to the other APs 102, as well as, or alternatively, subscribing to TWT schedules belonging to its associated AP 102 having RTSI subfield values of 0 or 1. In some aspects, the STA 104 associated with the transmitted BSSID may employ inheritance rules that are based on (such as exclusive to or otherwise associated with) such a parsing of TWT IE(s) within each nontransmitted BSSID profile and of TWT IE(s) outside of the multiple BSSID IE.

In some aspects, one or more wireless communication devices may elect such signaling mechanisms to prioritize efficiency in terms of signaling. For example, the one or more wireless communication devices may opt for such relatively more efficient signaling at the cost of additional processing and state maintenance at all associated STAs 104. For example, in such implementations, each associated STA 104 may process all TWT IE(s) within a management frame and track TWT schedules of each if not every other AP 102 in the multiple BSSID set (such as in accordance with or based on critical updates).

In some other implementations, for a multiple BSSID set, a management frame of a transmitted BSSID may carry a multiple BSSID IE and a TWT IE, and the TWT IE carried outside of the multiple BSSID IE may include R-TWT parameter sets for the transmitted BSSID (with RTSI subfield values set to 0, 1, or 2) and R-TWT parameter sets corresponding to a set of (such as all) nontransmitted BSSID(s) in that multiple BSSID set that are currently active (with RTSI subfield values set to 3). A TWT IE carried within the nontransmitted BSSID profile (contained within the Multiple BSSID element) may include R-TWT parameters for that particular nontransmitted BSSID (with an RTSI subfield value set to 0, 1, or 2) and R-TWT parameter sets corresponding to a set of other BSSIDs (such as every other BSSID) in that multiple BSSID set that are currently active (with RTSI subfield values set to 3).

In such implementations, a STA 104 receiving the management frame (such as the beacon frame or the probe response frame, among other examples) of the transmitted BSSID may parse the management frame based on with which BSSID the STA 104 is associated. In other words, a STA 104 may parse a TWT IE belonging to its profile and discard (such as ignore) other TWT IE(s) in the management frame. For example, if the STA 104 is associated with the transmitted BSSID, the STA 104 may parse the TWT IE outside of the multiple BSSID IE. Alternatively, if the STA 104 is associated with a nontransmitted BSSID, the STA 104 may parse the TWT IE within a nontransmitted BSSID profile corresponding to the nontransmitted BSSID with which the STA 104 is associated. The STA 104 may honor all R-TWT parameters having non-zero RTSI subfield values and may subscribe to an R-TWT schedule that has an RTSI subfield value of 0 or 1. In some aspects, one or more wireless communication devices may elect to employ such a signaling mechanism to reduce processing at wireless STAs 104 (such as to preserve or extend some element inheritance rules) at the cost of potentially larger signaling overhead (which, however, may be negligible or otherwise worth the benefit of lower STA processing if a quantity of APs 102 is relatively small).

In some systems, an AP 102 may include an R-TWT parameter set of other (friendly) APs 102 in a neighborhood of the AP 102. In accordance with the described techniques, a wireless communication device may employ or otherwise use or reference various criteria for determining a “friendly” AP 102, and may accordingly employ a mechanism (such as setting a RTSI subfield value to 3 and/or setting a broadcast TWT ID to 31, among other examples) to indicate (via a frame 204, which may be a beacon frame, a probe response frame, or any other management or advertising frame) that the R-TWT parameter set belongs to another friendly AP 102. In some aspects, a wireless communication device may report (such as indicate, advertise, or otherwise inform other devices of) the “active” TWT schedules. Such “active” schedules may be any TWT schedules having a corresponding RTSI subfield value set to 1 or 2. Such a determination of “friendly” APs 102 and such reporting may be applicable to various deployment scenarios, including to deployments in which other, potentially friendly APs 102 belong to a same multiple BSSID set, a same co-hosted BSSID set, or are non-collocated APs 102, or any combination thereof. Accordingly, with such signaling mechanisms, an AP 102 and its associated STAs 104 may honor (such as respect or otherwise refrain from performing transmissions during) the R-TWTs of neighboring (friendly) APs 102.

Further, in some implementations, one or more wireless communication devices may support one or more configuration- or signaling-based mechanisms associated with critical updates. In some implementations, for example, if an R-TWT parameter set (belonging to the transmitting AP 102 or an OBSS AP 102) is added or deleted from a TWT IE, such an addition or deletion may trigger a critical update. In some aspects, such a critical update may cause a field to change its value (such as trigger a wireless communication device to change a value of the field). Such a change in the value of the field may include one or more of a setting of a critical updates flag to 1 (such as the Critical Update Flag or Nontransmitted BSSIDs Critical Update Flag field), incrementing a parameter change count (such as the value carried in the BSS Parameter Change Count field), or an incrementing of a check beacon field value (such as the Check Beacon field in TIM frame). Additionally, or alternatively, a wireless communication device may define, add, generate, or otherwise support a field dedicated for tracking TWT (or specifically R-TWT) related changes or changes related to coordinated medium access operation. A wireless communication device may increment a value of such a field that is specific or dedicated to protected communication related changes each time there is an update (such as an addition or deletion of an R-TWT parameter set from a management frame, such as a beacon frame or a probe response frame). As such, client devices (such as one or more STAs 104) that do not support R-TWT may not be triggered to wake-up to check the update(s). In some aspects, the field may be carried in an element (such as TWT Extension element or a Coordinated Medium Access element) that may be dedicated for carrying additional information related to TWT operation. In such aspects, wireless communication devices may refrain from extending (such as increasing the size of) the TWT IE.

In some implementations, a change to an RTSI subfield value also may trigger a critical update. Such a change to an RTSI subfield value may include a schedule changing from inactive to active (as indicated by an RTSI subfield value changing from 0 to 1) or from active to inactive (as indicated by an RTSI subfield value changing from 1 to 0), a schedule changing from accepting no new membership to allowing new membership (as indicated by an RTSI subfield value changing from 2 to 1, or from 2 to 0) or from allowing new membership to accepting no new membership (as indicated by an RTSI subfield value changing from 1 to 2, or from 0 to 2), a schedule of an OBSS becoming active (which may cause a neighboring AP 102 to start reporting the schedule with an RTSI subfield value set to 3), or a schedule of an OBSS becoming inactive (which may cause a neighboring AP 102 to stop reporting, such as to remove the R-TWT parameter set corresponding to the OBSS AP 102 from a TWT IE of the neighboring AP 102).

Further, some implementations provide one or more configuration- or signaling-based mechanisms according to which a wireless communication device may select, identify, ascertain, detect, or otherwise determine a set or group of friendly APs 102 (which may be understood as a set or group of APs 102 with which the wireless communication device coordinates communication schedules). In other words, a wireless communication device may respect communication schedules (such as TWT or R-TWT schedules) of APs 102 that are identified as “friendly.” In some implementations, a wireless communication device may identify whether an AP 102 is “friendly” based on a service set ID (SSID) associated with the AP 102. For example, in such implementations, a wireless communication device may identify a set of (such as all) neighboring APs 102 in a same ESS as the wireless communication device as friendly. Additionally, or alternatively, a wireless communication device may identify whether an AP 102 is “friendly” based on advertising a group ID. For example, APs 102 may communicate (such as transmit or receive, or both) indications of respective group IDs and APs 102 having a same group ID may coordinate communication schedules (such as TWT schedules) with each other. Additionally, or alternatively, a wireless communication device may identify whether an AP 102 is “friendly” based on vendor or manufacturer specific mechanisms. For example, a set of (such as all) neighboring APs 102 associated with a same manufacturer or a same vendor may coordinate communication schedules (such as TWT schedules) with each other (such as honor or respect each other's communication periods).

Additionally, or alternatively, a wireless communication device may identify whether an AP 102 is “friendly” in accordance with neighbor-aware networking (NAN)-like mechanisms. For example, APs 102 may group together for the purpose of inter-AP coordination based on having a same group leader (such as an NAN anchor master), where a wireless communication device may determine that another wireless communication device has a same group leader in accordance with the two wireless communication devices exchanging (such as transmitting or receiving, or both) information associated with an identity of their respective group leaders.

Additionally, or alternatively, wireless communication devices may group together for the purpose of coordination in accordance with a dynamic formation. For example, a first wireless communication device (such as a first AP) may initially honor an R-TWT SP of a second wireless communication device from which the first wireless communication receives (such as hears) a management frame (such as a beacon frame or a probe response frame). The first wireless communication device may add the second wireless communication device to a group of coordinating APs (such as a coordinating AP set). The first wireless communication device may monitor OBSS transmissions that violate a communication period (such as an R-TWT SP) of the first wireless communication device and, if the violation is by the second wireless communication device, the first wireless communication device may remove the second wireless communication device from the group of coordinating APs. In some implementations, the first wireless communication device may remove the second wireless communication device after a threshold quantity of violations by the second wireless communication device, where such a threshold quantity may be any number, including 1, 2, 3, 4, and so on.

Further, in some implementations, the first wireless communication device may use the same (or a similar) violation-based rule to STAs 104 associated with the second wireless communication device AP 102. For example, the first wireless communication device may count or otherwise consider violations by a STA 104 associated with the second wireless communication device as being violations by the second wireless communication device itself. As such, a general rule associated with tracking a threshold quantity of violations for each coordinating AP 102 prior to no longer coordinating with that AP 102 may account for non-friendly (or non-R-TWT implementing) STAs 104.

Additionally, or alternatively, a wireless communication device may by default (such as always or in accordance with a standard or network configuration) respect TWT schedules of all other APs 102 in the neighborhood that can be heard by the wireless communication device. As such, coordinating wireless communication devices may not define or track a selective group of coordinating APs 102, and may instead expect all known APs 102 in the neighborhood of each other to be coordinating APs 102. In such implementations, APs 102 may exchange additional information or support additional prioritization rules to avoid channel access starvation at a wireless communication device, such as a wireless communication device that starts late or has a low-latency flow that started late and that may not have sufficient time remaining to setup its own R-TWT schedule because all (or most) of the medium time is taken or reserved by other (neighboring) APs 102.

Further, although described in the context of TWT schedules (such as R-TWT schedules), any group formation mechanisms described herein may apply to any form of coordinated medium access. For example, such group formation mechanisms may be applicable to coordinated R-TWT, TXOP sharing, differentiated channel access (such as differentiated EDCA), or any other medium access coordination or prioritization techniques.

To support coordination within a group of coordinating APs, for mechanisms associated with respecting TWT schedules of APs 102 that are identified as friendly or NAN-like mechanisms, the group may be predetermined (such as preconfigured or otherwise determined, identified, or selected in advance of (such as prior to) data scheduling) and the described signaling mechanisms may involve some form of backend support. As such, APs 102 may be provisioned with additional information that can aid coordination. For example, APs 102 may provide scheduling information to each other. Such scheduling information may include information pertaining to coordination of R-TWTs, such as which devices can go (such as communicate) together (such as which R-TWTs may overlap in time) or which R-TWTs (or which device's R-TWTs) are expected to be orthogonal (such as non-overlapping in time and frequency) with any other R-TWTs, among other examples. Additionally, or alternatively, such scheduling information may include information pertaining to TXOP sharing, such as which AP 102 shares (or is able or allowed to share) with which other AP(s) 102. In some implementations, a centralized entity (such as an anchor or master AP 102) may provide a security key for secure communication between the APs 102.

To support coordination within a group of coordinating APs 102, for mechanisms associated with dynamic formations or always respecting TWT schedules of all detected APs 102 in the neighborhood, the group may not be present or may be dynamic. As such, APs 102 may include security information within a coordination frame itself. For example, when an AP 102 shares a TXOP with another AP 102, the frame that distributes the schedule may include security information or session information to provide some degree of secure communication between the APs 102. In other words, APs 102 may include security information or session information in coordination frames to assist or aid in an authentication of each other (such as an authentication of that AP 102 as a coordinating AP 102). In some aspects, the security information may be a transient key, such as a key that changes in every frame and is authenticated. In such aspects, the key may be based on a group key of an AP 102.

Further, the described techniques may provide mechanisms associated with channel access within a TWT, such as within an R-TWT. In some systems, one or more rules may dictate that an in-BSS STA 104 terminates a TXOP prior to a start of an R-TWT SP. Further, at the start of an R-TWT SP, all (or a set of) in-BSS devices may restart respective counters (such as a backoff counter or a random backoff counter) associated with contention to gain access to the medium. Additionally, or alternatively, an AP 102 may advertise a quieting period (such as a quiet interval) so that the AP 102 that owns the TXOP has priority to gain access. Such a quieting period may be relatively short, such as approximately 1 millisecond.

With coordinated medium access, APs 102 (and their associated STAs 104) may coordinate and respect each other's communication schedules, such as each other's R-TWT schedules. However, in some (dense) deployments, it may still be possible to have multiple APs 102 have overlapping R-TWTs. In such deployments, there may be multiple devices simultaneously competing to gain access to the medium, which may lead to collisions amongst the friendly APs 102. To overcome this issue, an AP 102 that owns the TXOP may have a prioritized access. Such prioritized access can be accomplished by (such as associated with) a quieting period advertised to other, competing devices or other means, such as using a smaller countdown value (such as a smaller arbitration inter-frame spacing number (AIFSN) or a smaller contention window (CW) value).

In some implementations, one or more wireless communication devices may support a TWT extension element (and/or a Coordinated Medium Access element) and/or a follow-up frame (such as a follow-up management frame, for example, a follow-up beacon frame). For example, because elements carried in a management frame of an AP 102 may be received and processed by both STAs 104 capable of protected communication (such as R-TWTs) and STAs 104 incapable of protected communication (such as R-TWTs), including timing information pertaining to protected communication in a TWT extension element (and/or a Coordinated Medium Access element) and/or a follow-up (separate) frame may increase or preserve a backward compatibility of TWT IEs transmitted within management frames.

Accordingly, in some implementations, the described wireless communication devices may support an element (such as a TWT extension element) and/or an element dedicated for coordinated medium access (such as a Coordinated Medium Access element) to carry additional information related to TWT schedules for the transmitting AP 102 or one or more OBSS APs 102 and other information related to medium access coordination. Such additional information may be usable for greater timing granularity, indicating an (OBSS) AP identifier, carrying R-TWT information of one or more OBSS APs 102, and the like. In some implementations, the element may be carried (included) in a follow-up frame (such as a Beacon-A frame) to offload some information from the management frame (such as the beacon frame). In some implementations, a wireless communication device may transmit the follow-up frame right after (such as approximately immediately after, such as within a SIFS duration) the management frame. The follow-up frame may be another management or advertising frame, such as a form of beacon frame or a form of probe response frame, among other examples.

In some implementations, a wireless communication device may include an indication in the management frame to inform STAs 104 if they are expected to remain awake to listen for (and process) the follow-up frame (such as the Beacon-A frame). For example, an indication may inform receiving STAs 104 that additional (R-) TWT information is included in the follow-up frame. Further, in some implementations, the follow-up frame may include any other information sometimes included in a management frame and the management frame may include one or more indications of which information is offloaded from the management frame to the follow-up frame. In some aspects, the follow-up frame may carry a TWT IE (and/or a TWT extension element and/or a Coordinated Medium Access element) containing information of OBSS APs 102. For example, the R-TWT IE in the beacon may exclusively carry information of the transmitting AP 102 (and other APs 102 in a collocated or MBSSID set) while the information of non-collocated APs 102 is carried in the follow-up frame (via another TWT IE, TWT extension element, or a Coordinated Medium Access element included in the follow-up frame).

In some implementations, a wireless communication device may schedule (protected) communication periods to achieve or enable TBTT protection. For example, one or more APs 102 may learn about R-TWT schedules of other APs 102, as well as other information pertaining to coordination, by listening to one or more management frames (such as beacon frames) of neighboring APs 102, where a receiving AP 102 may record a R-TWT parameter set that has an RTSI subfield value set to 0, 1, or 2 (because those belong to the transmitting AP 102). Further, if a neighboring AP 102 belongs to a multiple BSSID set, a receiving AP 102 may be expected to consider the active schedules for a set of (such as all) the BSSIDs (by monitoring the nontransmitted BSSID profiles as well, because the transmitted BSSID profile may advertise any corresponding TWT schedules with an RTSI subfield value of 3). Additionally, or alternatively, APs 102 may exchange explicit frames to provide R-TWT schedule(s) of each other, as well as other information pertaining to inter-AP coordination. Further, APs 102 may exchange or otherwise learn (such as obtain) other pieces of information (such as pieces of information useful for other UHR mechanisms, such as multi-AP associated with C-TDMA) by listening to beacon frames (and any follow-up frames) transmitted by each other. Moreover, while described in the context of R-TWT, the described techniques may apply to any other coordination schemes (such as C-TDMA and the like). As such, it may be desirable for APs 102 to avoid collisions of beacon frames (and any follow-up frames).

Accordingly, in some implementations, a wireless communication device may establish a protected communication schedule (such as an R-TWT schedule) for protecting TBTTs of the wireless communication device. In some aspects, the wireless communication device may set an RTSI subfield value corresponding to such a protected communication schedule to 2 or 3 to protect the associated communication periods and avoid (such as preempt) any subscription requests associated with the protected communication schedule. Additionally, or alternatively, the wireless communication device may advertise a broadcast TWT ID as a value 31 (such as all 1 bits) to protect the associated communication periods and avoid (such as preempt) any subscription requests associated with the protected communication schedule. Further, although described in the context of using protected communication periods to protect TBTTs, the described techniques may be used to similarly protect any other periodic communication.

Further, in some implementations, one or more wireless communication devices may support A-Control based signaling. For example, the described techniques may provide A-Control based signaling between APs 102. In some aspects, an HT Control field in a MAC header of a frame can be used to piggyback information to a receiving device (such as a receiving STA 104), where a receiver can be an AP 102 or a non-AP STA. In other words, piggybacking information via an HT Control field may be used in the uplink or downlink direction. An HT Control frame may be included in various frame types, including in a QoS null frame, a QoS data frame, or a management frame. Various communication mechanisms or schemes may leverage signaling via HT Control (A-Control). For example, in TXS-based sharing, a shared AP 102 may return a shared TXOP via CAS control. A-Control based signaling may be carried in a unicast frame and may be limited to associated peers. For example, a QoS null frame and a QoS data frame can be exchanged (such as only exchanged) between associated peers.

Some systems (such as UHR systems), however, may involve several mechanisms that may involve AP-to-AP coordination. Because two APs 102 may not be associated with each other, a QoS null frame or a QoS Data frame may not be able to be used. Public action (management) frames can be exchanged between two devices in unassociated state. As such, public action frames may be a suitable candidate to carry A-Control information between two APs 102 in accordance with AP-to-AP coordinated medium access. Each public action frame, however, may be designated to carry specific information and there may be a specific action associated with a given public action frame upon receiving such a frame.

In some implementations, to use public action frames for coordinated medium access between multiple APs 102, wireless communication devices may use (and may define) a (null) public action frame. Such a frame may lack a frame body and instead include only a MAC header. For example, a TXOP shared AP 102 can return the TXOP via a (Null) public action frame carrying CAS Control in the HT Control field (such as an HE-variant HT control field, such as an A-control subfield which may be defined or supported specifically for coordinated medium access) of the MAC header of the public action frame (which may be a type of management frame). Additionally, or alternatively, the frame can include a field or an element (such as multi-link ID element) to identify the link(s) for which the A-Control information (such as information pertaining to coordinated medium access) applies. For example, such a field or element may include a bitmap or some other information indicating to which link(s) coordinated medium access information is applicable.

In some other implementations, a field in the MAC header of the public action frame may indicate that the contents of the frame body are to be ignored. In other words, the field may indicate that only the MAC header carries useful information and is the purpose of this frame, such that any receiving devices parse (such as decode) the MAC header and ignore (such as discard or refrain from parsing) the frame body. Across both implementations, the public action frame may be sent via unicast signaling (1:1 communication between two APs 102, where the RA is the intended AP's MAC address) or sent to a broadcast address to disseminate the information (such as the information pertaining to coordinated medium access) to multiple APs 102. In some aspects, wireless communication devices may support a dedicated or specific broadcast address for public action frames that include a field indicating that only the MAC header carries useful information (where the RA of such public action frames is set to such a dedicated or specific broadcast address) such that devices incapable of coordinated medium access ignore the frame.

Further, in accordance with some implementations of the present disclosure, wireless communication devices may support one or more interpretations of a TWT field. In some aspects, such different interpretations may be based on an indication carried in the same frame (such as in the same frame that carries the TWT field). In some cases, the indication may be carried in the same TWT element (such as via the value of a TWT wake interval in the Broadcast TWT Parameter Set field). For example, the TWT field that is carried in the TWT element inside the broadcast TWT parameter set may carry an indication of a TSF timer value that corresponds to a first R-TWT SP start time (such as the first (reference) R-TWT SP start time that happens (such as occurs) after the first TBTT (Time 0) or the first R-TWT SP start time of the schedule). When the first R-TWT SP start time corresponds to the start time of the first R-TWT SP in the schedule, additional information about the TSF timer corresponding to the start time (such as Bits 26 to 63 or Bits 0 to 9) may be provided in the same frame (such as in a TWT Constraint Parameters element or another element associated with indicating one or more TWT parameters) or in another frame. As such, devices may enable or support a sub-1 time unit (TU) granularity in the subsequent R-TWT SP start time, which may enable or allow SP start times to match various traffic patterns (such as an XR traffic pattern, where traffic may arrive every approximately 16.667 milliseconds). In some other systems, such a sub-1 TU granularity indication of TWT start times may not be supported for Broadcast TWT signaling, where the subsequent SP start times of a schedule may be constrained to a TU level granularity (such as TSF timer values in integer multiples of 1 TU). As such, if a STA 104 infers an R-TWT as a B-TWT, there may be a mismatch in the interpretation of the intended time of the SPs between an R-TWT AP 102 and the STA 104 that incorrectly infers an indicated R-TWT as a B-TWT. For example, with the some signaling mechanisms, a STA 104 may interpret the TWT field in the R-TWT parameter set as a next TWT SP start time, whereas the AP 102 in case of R-TWT SP may announce the first R-TWT SP time, such that the STA 104 that supports b-TWT STA may interpret this time as a time in the past and hence may assume that this schedule is not valid (and ignore it accordingly).

Accordingly, in some implementations of the present disclosure, wireless communication devices may support at least two interpretations of the TWT field. If the sub 1 TU granularity is not used, wireless communication devices may fall back to a baseline way of announcing the next TWT SP start time (as opposed to the first or initial TWT SP start time). As such, wireless communication devices may allow or otherwise support backward compatibility for STAs 104 that support broadcast TWT and request to join an R-TWT schedule. In such a case, the TWT field may be interpreted as a next R-TWT SP start time if the TWT wake interval is in units of TU (such that a modulo of TWT wake interval with respect to 1 TU is zero, for example, mod (TWT Wake Interval, 1024)=0). Alternatively, the TWT field for R-TWT may be interpreted as indicating a first R-TWT SP start time based on the TWT wake interval being not in integer units of TU. Another interpretation may be associated with how broadcast TWT capable devices interpret the TWT field, where the TWT field corresponds to the next R-TWT SP start time (instead of the first R-TWT SP start time). Such interpretation mechanisms may apply to various systems, including UHR systems, for coordinated medium access (such as R-TWT coordination amongst APs 102).

As described herein, R-TWT may be understood as a variant of B-TWT and some STAs 104 may understand or interpret R-TWT as B-TWT. For example, non-R-TWT capable STAs 104 may not understand an RTSI subfield (and hence may not understand an RTSI subfield value of 2 or 3) and, therefore, may attempt to join a corresponding TWT (which may actually be an R-TWT) as a B-TWT. A similar interpretation issue may occur for R-TWTs that have a broadcast TWT ID set to 31 (such as all 1 bits) for differentiation or for other scenarios (such as timing) involving R-TWT. As such, in some implementations, and because any TWT setup is a negotiation, an AP 102 may reject (and/or suggest an alternative TWT schedule) if the AP 102 receives a TWT setup request from a non-R-TWT capable STA 104.

In accordance with one or more of the described coordinated medium access mechanisms, the AP 102-a, for example, may obtain information pertaining to first communication periods, which may be communication periods corresponding to other APs 102 (such as one or more of the AP 102-b and the AP 102-c). Such first communication periods may include time periods or time epochs associated with B-TWTs, R-TWTs, C-TDMA, and the like. The AP 102-a may determine or schedule second communication periods based on the first communication periods. For example, as possible, the AP 102-a may schedule the second communication periods (which may correspond to time periods or time epochs associated with B-TWTs, R-TWTs, C-TDMA, and the like for communication between the AP 102-a and its associated STAs 104, such as the STA 104-a) to avoid overlapping (in time or frequency, or both) with the first communication periods. For example, and as illustrated by the example of FIG. 2, the second communication periods may include a communication period 206-a and a communication period 206-b, while the first communication periods may include a communication period 208-a, a communication period 210-a, a communication period 208-b, and a communication period 210-b. In some aspects, the communication period 208-a and the communication period 208-b may correspond to the AP 102-b and the communication period 210-a and the communication period 210-b may correspond to the AP 102-c.

The AP 102-a may transmit the frame 204 (which may be one or more management frames, including one or more of a beacon frame, a follow-up beacon frame, a probe response frame, or a public action frame) to indicate information (such as timing information) pertaining to at least the second communication periods corresponding to the AP 102-a. In some implementations, the AP 102-a may additionally indicate information (such as timing information) pertaining to the first communication periods via the frame 204. As described herein, the AP 102-a may indicate such information (such timing information) via a set of fields (such as a set of parameter set fields, such as TWT parameter set fields, where each parameter set field may indicate a schedule of communication periods) of the frame 204, which may include fields outside of a multiple BSSID IE of the frame 204 and/or fields within a multiple BSSID IE of the frame 204. In some implementations, the AP 102-a may use a configured set of IDs to distinguish the second communication periods from the first communication periods, where such a configured set of IDs may refer to one or both of a broadcast TWT ID or an RTSI subfield value, among other example IDs or values that may be used to distinguish between TWT schedules that associated STAs 104 may use and TWT schedules that associated STAs 104 are expected to avoid.

The AP 102-a and the STA 104-a may communicate (such as transmit or receive, or both) during one or both of the communication period 206-a and the communication period 206-b. Further, in some implementations, other STAs 104 not associated with the AP 102-a may receive the frame 204 and obtain the indicted information associated with coordinated medium access. In such implementations, such an unassociated STA 104 may communicate in accordance with the indicated information (such as in accordance with the second communication periods). Such communication in accordance with the second communication periods may be understood as communication during any one or more of the second communication periods (if the STA is associated with the AP 102-a) or as communication avoiding the second communication periods (if the STA is not associated with the AP 102-a). As described herein, which IEs (and likewise which parameter set fields) of the frame 204 a STA 104 parses may be based on whether the STA 104 is associated with the transmitted BSSID and/or based on which signaling or frame format construction mechanism the AP 102-a employs (such as based on in which fields or IEs the AP 102-a includes information pertaining to the first communication periods and the second communication periods).

FIG. 3 shows an example of a frame format 300 that supports techniques for coordinated medium access for ultra-high reliability according to some aspects of the present disclosure. The frame format 300 may illustrate an example format of the frame 204 as illustrated by and described with reference to FIG. 2. For example, the frame format 300 may be a format of a frame 204 that provides information pertaining to coordinated medium access (such as timing information including, for example, any one or more of TWT information, R-TWT information, B-TWT information, TXOP sharing information, C-TDMA information, and the like). In some aspects, the frame 204 may include a various sections, including a MAC header (which may include a set of initial elements or fields of the frame 204, such as a frame control field and/or a duration field, among other fields) and a frame body 302 (which may include another set of elements or fields of the frame 204).

In some aspects, the frame body 302 may include one or more elements (each identified by a corresponding ID), a multiple BSSID element 304, and one or more vendor specific elements (each identified by a corresponding ID). Each vendor specific element may include an organization identifier field and a content field. In some aspects, the multiple BSSID element 304 (which may be equivalently referred to herein as a multiple BSSID IE) may include an element ID field, a length field, a maxBSSID indicator field, and one or more nontransmitted BSSID profiles 308. Further, such one or more elements may refer to any one or more IEs described herein, such as a TWT IE 306. The TWT IE 306 may be understood as a TWT IE outside of the multiple BSSID IE. In some aspects, the TWT IE 306 may include one or multiple TWT parameter set fields, where each parameter set field indicates a TWT schedule (such as a B-TWT schedule or an R-TWT schedule).

Each nontransmitted BSSID profile 308 (which may be equivalently referred to herein as a non-TxBSSID profile) may include a sub-element ID subfield, a length subfield, and a data subfield. A data subfield may include a nontransmitted BSSID capability subfield, an SSID subfield, a multiple BSSID-index subfield, one or more elements (each identified by a corresponding ID), one or more vendor specific elements (each identified by a corresponding ID), and a non-inheritance subfield. Such one or more elements may refer to any one or more IEs described herein, such as a TWT IE (where such a TWT IE may be understood as being within a nontransmitted BSSID profile 308). In some aspects, a TWT IE within a nontransmitted BSSID profile 308 may include one or multiple TWT parameter set fields, where each parameter set field indicates a TWT schedule (such as a B-TWT schedule or an R-TWT schedule).

In some aspects, an element or a vendor specific element included in a nontransmitted BSSID profile 308 may override a same element or a same vendor specific element included outside of the multiple BSSID element 304 (where same elements are identified based on such elements being identified by a same ID). Otherwise, if a STA parses an element outside of the multiple BSSID element 304 and that same element (as identified by an ID) is not included in a nontransmitted BSSID profile 308, the STA may inherit (and communicate in accordance with) the information conveyed via the element outside of the multiple BSSID element 304. Such inheritance may be understood as multiple BSSID inheritance.

In some aspects, each TWT parameter set field may be associated with an RTSI subfield, where a value of the RTSI subfield indicates various information pertaining to the corresponding TWT schedule. Example values of the RTSI subfield are shown and explained below in the context of Table 1. As described herein, an RTSI subfield may be an example of a schedule information subfield.

TABLE 1
Example RTSI Subfield Values

| Restricted TWT | |
|---|---|
| Schedule Info | Description when included in a Restricted TWT Parameter |
| subfield value | Set field |
| 0 | The corresponding R-TWT schedule does not have any member |
| | STAs or the schedule is suspended for all the member STAs. |
| | Such an R-TWT schedule may be referred to as an idle R-TWT |
| | schedule. |
| 1 | The corresponding R-TWT schedule has at least one member |
| | STA for which the schedule is not suspended. Such an R-TWT |
| | schedule may be referred to as an active R-TWT schedule. |
| 2 | Indicates an active R-TWT schedule for which the R-TWT |
| | scheduling AP is unlikely to accept a request from a STA in the |
| | BSS to establish a new membership. Such an R-TWT schedule |
| | may be referred to as a full R-TWT schedule (such as the AP |
| | might not have sufficient resources within this schedule for |
| | accepting new memberships). |
| 3 | Indicates that the advertised R-TWT schedule is active and is |
| | for an AP corresponding to a nontransmitted BSSID that is a |
| | member of the same multiple BSSID set or co-hosted BSSID set |
| | as the AP transmitting the Restricted TWT Schedule Info |
| | subfield. |

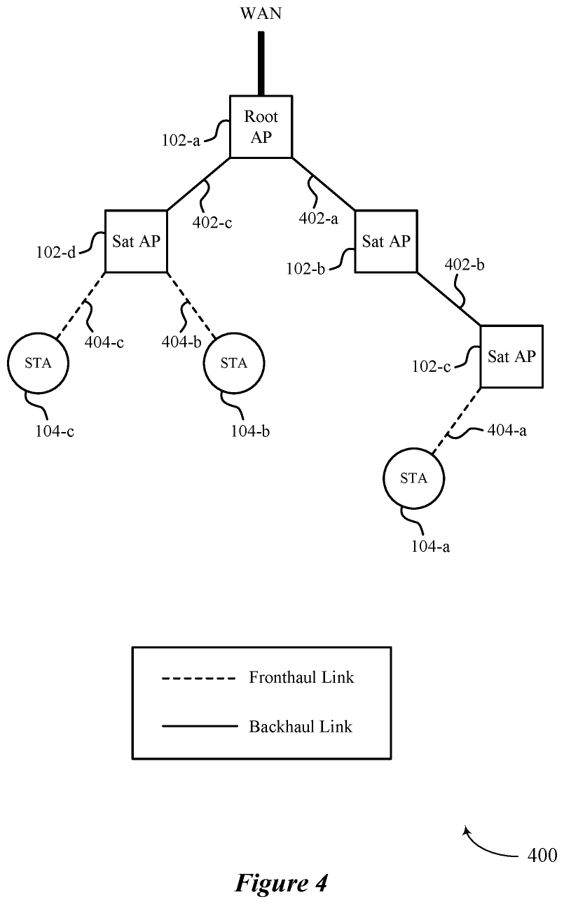

FIG. 4 shows an example of a wireless communication system 400 that supports techniques for coordinated medium access for ultra-high reliability according to some aspects of the present disclosure. The wireless communication system 400 illustrates communication between various wireless communication devices in accordance with a mesh-like or mesh-based system topology.

For example, the wireless communication system 400 illustrates communication between a root AP 102-a, satellite APs 102-b, 102-c, and 102-d, and wireless STAs 104-a, 104-b, and 104-c. The root AP 102-a and the satellite APs 102-b, 102-c, and 102-d may communicate with each other via one or more backhaul links. Each of the wireless STAs 104-a, 104-b, and 104-c may communicate with at least one AP 102 (and potentially multiple APs 102) via at least one fronthaul link. In some aspects, the root AP 102-a may be directly connected to the internet, which may be referred to as or otherwise understood as a wide area network (WAN). The satellite APs 102-b, 102-c, and 102-d may be indirectly connected to the internet via at least the root AP 102-a. As such, a satellite AP 102 may directly or indirectly relay data traffic between the root AP 102-a (the internet) and one or more wireless STAs 104.

In the example of the wireless communication system 400, the root AP 102-a may communicate with the satellite AP 102-b via a backhaul link 402-a, the satellite AP 102-b may communicate with the satellite AP 102-c via a backhaul link 402-b, and the root AP 102-a may communicate with the satellite AP 102-d via a backhaul link 402-c. As further illustrated in the example of the wireless communication system 400, the satellite AP 102-c may communicate with the wireless STA 104-a via a fronthaul link 404-a and the satellite AP 102-d may communicate with the wireless STA 104-b and the wireless STA 104-c via a fronthaul link 404-b and a fronthaul link 404-c, respectively. As described herein, a wireless communication device may refer to any of the root AP 102-a, the satellite APs 102-b, 102-c, and 102-d, or the wireless STAs 104-a, 104-b, and 104-c. Moreover, any of such wireless communication devices may leverage the described coordinated medium access techniques in relay topologies, such as across one or multiple hops of a multi-hop relay path between the root AP 102 and an edge client (such as, for example, the STA 104-a).

In some implementations, various wireless communication devices may support medium access coordination in a relay topology. In some aspects, operating at an intermediate STA (such as a relay AP) may be simplified when minimal processing is involved. In some aspects, not changing a size of relayed frames may be associated with one manner of limiting an amount of involved processing. A frame transmitted for or received from an edge client may be in a 3-address format. For example, the frame may include an RA, a TA, and either a source address (SA) or a destination address (DA) depending on the direction (such as uplink or downlink) in which the frame is transmitted. In some systems, however, a frame transmitted by a root AP 102-a and intended for an edge client may be configured to be in a 4-address format (including each of an RA, a TA, a DA, and an SA). As such, it may be desirable to have a mechanism that enables all frames traversing a relay STA (such as being transmitted along a multi-hop relay path) to be in a 3-address format for lower processing, but some systems may preempt some benefits associated with lower processing by using the 4-address format for frames transmitted by a root AP and intended for an edge client.

In some implementations of the present disclosure, during association, the edge client may be assigned an association identifier (AID). In some aspect, an edge relay STA that is currently serving the client or with whom the edge client performs association may report, to a root AP 102-a (such as by transmitting a frame to the root AP 102), a MAC address and the AID of the edge client. The root AP 102-a may map the (MAC) address of the client with an AID. Accordingly, in (all) frame exchanges intended for the edge client, the AID of the client may be used as an identifier (such as instead of a 6-octet address field). In some aspects, the AID may be carried in the A-Control field (such as a high throughput (HT) Control field), which may be present in a QoS data frame. Such an A-Control field may be a high efficiency (HE)-variant HT control field, which may be defined or supported specifically for coordinated medium access. Additionally, or alternatively, the AID information (which may be expressed as STA_ID) may be carried in a preamble (such as a PHY header) of a PPDU carrying the frame.

For downlink communication, when constructing a frame intended for the edge client, the root AP 102-a may generate a 3-address MAC protocol data unit (PDU) (MPDU) (in accordance with including the AID of the edge client instead of a 6-octet address field). As the frame traverses intermediate relay APs 102 (such as satellite APs 102), the size of the frame may stay the same because the format of the frame (the MPDU) remains a 3-address format (with only the RA and TA changing at any given hop along a multi-hop relay path). In a final hop (such as at a final satellite AP 102 or relay STA prior to the edge client), an edge relay device may use the AID of the edge client to identify, select, calculate, or otherwise determine the MAC address for the edge client. The edge relay device may include the MAC address for the edge client in the RA address of the MPDU the edge relay device transmits to the edge client accordingly. In some implementations, the AID may not be included in the HT Control field (A-Control field) in the final hop because the edge client may not expect the AID (such as may not expect the AID to address the edge client).

For uplink communication, when an edge relay device receives a frame from an edge client, the edge relay device may use the MAC address of the edge client to identify, select, calculate, or otherwise determine the AID of the edge client. Accordingly, the edge relay device may include the AID in the A-Control field of the frame (an MPDU) being transmitted upstream to the next hop relay device or the root AP 102-a. In some aspects, as the frame traverses intermediate relay APs 102, a size of the frame may remain the same because the format of the frame (the MPDU) remains a 3-address format (with only the RA and TA changing at any given hop along a multi-hop relay path).

As such, the described techniques may not necessitate a change in a MAC frame header size when a frame is relayed by an intermediate STA, which may limit complexity and processing costs as well as save overhead (because the A-control subfield may be 26 bits whereas the MAC address, if included, would have been 6 octets). Further, the described techniques may simplify the procedure and processing at each relay AP 102 and/or at the root AP 102-a as, in some implementations, a hardware may relatively quickly replace addresses without having to change a size of each frame.

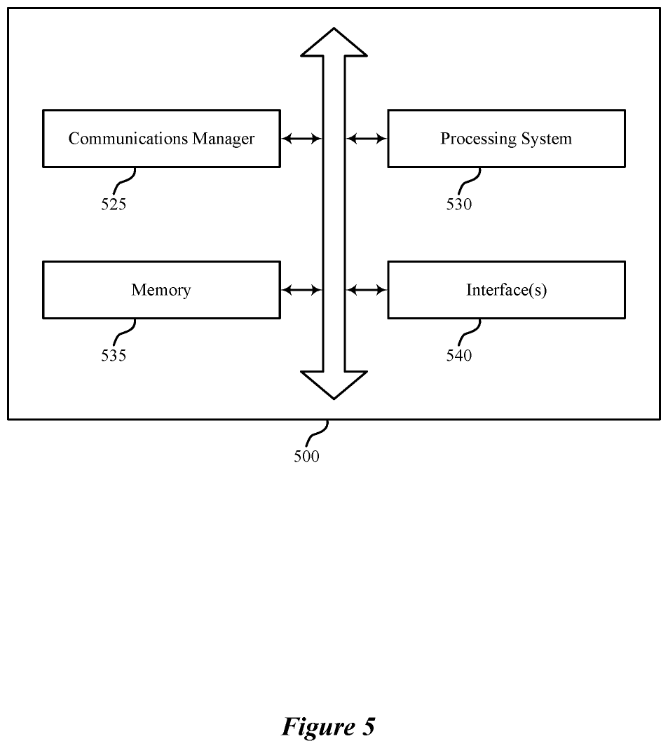

FIG. 5 shows a block diagram of an example wireless communication device 500 that supports techniques for coordinated medium access for ultra-high reliability according to some aspects of the present disclosure. In various examples, the wireless communication device 500 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory” 535).

In some implementations, the wireless communication device 500 can be a device for use in an AP, such as AP 102 described with reference to FIG. 1. In some other examples, the wireless communication device 500 can be an AP that includes such a chip, SoC, chipset, package or device as well as multiple antennas. The wireless communication device 500 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 500 also includes or can be coupled with an application processor which may be further coupled with another memory 535. In some implementations, the wireless communication device 500 further includes at least one external network interface that enables communication with a core network or backhaul network to gain access to external networks including the Internet.

The wireless communication device 500 includes a communications manager 525. Portions of the communications manager 525 may be implemented at least in part in the hardware or firmware. For example, the communications manager 525 may be implemented at least in part by a modem. In some implementations, the communications manager 525 may be implemented at least in part by a processor and as software stored in memory 535. For example, portions of the communications manager 525 can be implemented as non-transitory instructions (or “code”) executable by the processor to perform the functions or operations of the respective module.

In some implementations, the processor may be a component of a processing system 530. A processing system 530 may generally refer to a system or series of machines or components that receives inputs and processes the inputs to produce a set of outputs (which may be passed to other systems or components of, for example, the wireless communication device 500). For example, a processing system 530 of the wireless communication device 500 may refer to a system including the various other components or subcomponents of the wireless communication device 500, such as the processor, or a transceiver, or a communications manager 525, or other components or combinations of components of the wireless communication device 500. The processing system 530 of the wireless communication device 500 may interface with other components of the wireless communication device 500, and may process information received from other components (such as inputs or signals) or output information to other components. For example, a chip or modem of the wireless communication device 500 may include a processing system 530, a first interface 540 to output information and a second interface 540 to obtain information. In some implementations, the first interface 540 may refer to an interface between the processing system 530 of the chip or modem and a transmitter, such that the wireless communication device 500 may transmit information output from the chip or modem. In some implementations, the second interface 540 may refer to an interface between the processing system 530 of the chip or modem and a receiver, such that the wireless communication device 500 may obtain information or signal inputs, and the information may be passed to the processing system 530. A person having ordinary skill in the art will readily recognize that the first interface 540 also may obtain information or signal inputs, and the second interface 540 also may output information or signal outputs.

The wireless communication device 500 may support wireless communication in accordance with examples as disclosed herein. The communications manager 525 is capable of, configured to, or operable to support a means for obtaining first timing information pertaining to first communication periods that correspond to a set of access points (APs). In some implementations, the communications manager 525 is capable of, configured to, or operable to support a means for transmitting, based on coordination with the first timing information, one or more management frames indicating at least second timing information pertaining to second communication periods that correspond to the first wireless communication device, the one or more management frames distinguishing the second communication periods from the first communication periods in accordance with a configured set of identifiers (IDs) that correspond to the first communication periods and the second communication periods. In some implementations, the communications manager 525 is capable of, configured to, or operable to support a means for communicating with one or more wireless stations (STAs) associated with the first wireless communication device during at least a subset of the second communication periods.

In some implementations, the communications manager 525 is capable of, configured to, or operable to support a means for transmitting the first timing information within a first set of fields of a first information element of the one or more management frames, where each respective first ID field associated with the first set of fields includes a same ID of the configured set of IDs. In some implementations, the communications manager 525 is capable of, configured to, or operable to support a means for transmitting the second timing information within a second set of fields of the first information element of the one or more management frames, where each respective second ID field associated with the second set of fields includes a unique ID of the configured set of IDs.

In some implementations, each respective first ID field associated with the first set of fields includes the same ID of the configured set of IDs to distinguish the first communication periods as corresponding to one or more overlapping basic service sets (OBSSs). In some implementations, unique IDs for each respective second ID field associated with the second set of fields differentiates the second communication periods into one or more schedules of communication periods of the first wireless communication device.

In some implementations, the first wireless communication device is a restricted target wake time (R-TWT) scheduling AP that is announcing an R-TWT schedule with a restricted TWT schedule information subfield value set to three. In some implementations, the R-TWT scheduling AP is to set a broadcast TWT ID subfield to a fixed value in a broadcast TWT field corresponding to the R-TWT schedule in accordance with announcing the R-TWT schedule with the restricted TWT schedule information subfield set to three.

In some implementations, the communications manager 525 is capable of, configured to, or operable to support a means for transmitting a first subset of the first timing information within a first set of fields of a first information element of the one or more management frames. In some implementations, the communications manager 525 is capable of, configured to, or operable to support a means for transmitting the second timing information within a second set of fields of the first information element of the one or more management frames. In some implementations, the communications manager 525 is capable of, configured to, or operable to support a means for transmitting a second subset of the first timing information within a third set of fields of a second information element of the one or more management frames.

In some implementations, the first subset of the first timing information pertains to a first subset of the first communication periods, the first subset of the first communication periods corresponding to a first set of APs associated with the first wireless communication device. In some implementations, the second subset of the first timing information pertains to a second subset of the first communication periods, the second subset of the first communication periods corresponding to a second set of APs non-collocated with the first wireless communication device.

In some implementations, each respective first ID field associated with the first set of fields and the second set of fields includes a unique ID of the configured set of IDs. In some implementations, each respective second ID field associated with the third set of fields includes respective identification information corresponding to a respective AP of a second set of APs non-collocated with the first wireless communication device.

In some implementations, the second information element is an extension element. In some implementations, the respective identification information includes respective basic service set (BSS) ID identifying information.

In some implementations, the communications manager 525 is capable of, configured to, or operable to support a means for transmitting the first timing information within a first set of fields of the one or more management frames, where a respective first schedule information subfield value of each of the first set of fields is set to a same value in accordance with the first communication periods corresponding to the set of APs (such as matching to a corresponding AP in the set of APs), the set of APs belonging to a same co-hosted basic service set (BSS) ID set as the first wireless communication device. In some implementations, the communications manager 525 is capable of, configured to, or operable to support a means for transmitting the second timing information within a second set of fields of the one or more management frames, where a respective second schedule information subfield value of each of the second set of fields is set to a value from a set of multiple values in accordance with the second communication periods corresponding to the first wireless communication device.

In some implementations, the respective first schedule information subfield value is a dedicated value of a schedule information field that indicates that a corresponding schedule of communication periods is for one of the set of APs. In some implementations, the set of multiple values is a set of values of the schedule information field that indicates that a corresponding schedule of communication periods is for the first wireless communication device.

In some implementations, the communications manager 525 is capable of, configured to, or operable to support a means for transmitting exclusively the second timing information within a set of fields of the one or more management frames, where a respective schedule information subfield value of each of the set of fields is set to a value from a set of multiple values in accordance with the second communication periods corresponding to the first wireless communication device. In some implementations, the communications manager 525 is capable of, configured to, or operable to support a means for excluding the first timing information from the one or more management frames in accordance with the first communication periods corresponding to the set of APs (such as matching to a corresponding AP in the set of APs), the set of APs belonging to a same co-hosted basic service set (BSS) ID set as the first wireless communication device.

In some implementations, the set of multiple values is a set of values of a schedule information field that indicates that a corresponding schedule of communication periods is for the first wireless communication device.

In some implementations, the communications manager 525 is capable of, configured to, or operable to support a means for transmitting the first timing information within a first set of fields of a first information element of the one or more management frames, the first information element being outside of a multiple basic service set (BSS) ID information element. In some implementations, the communications manager 525 is capable of, configured to, or operable to support a means for transmitting the second timing information within a second set of fields of the first information element of the one or more management frames. In some implementations, the communications manager 525 is capable of, configured to, or operable to support a means for transmitting respective subsets of the first timing information within respective fields of respective nontransmitted BSSID sub-element of the multiple BSSID information element (which may be equivalently referred to as a multiple BSSID element).

In some implementations, a respective first schedule information subfield value of each of the first set of fields is set to a same value in accordance with the first communication periods corresponding to the set of APs (such as matching to a corresponding AP in the set of APs). In some implementations, a respective schedule information subfield value of each of the second set of fields is set to a value from a set of multiple values in accordance with the second communication periods corresponding to the first wireless communication device.

In some implementations, each respective nontransmitted BSSID sub-element of the multiple BSSID information element includes a respective subset of the first timing information and excludes a remainder of the first timing information. In some implementations, a schedule information subfield of that respective nontransmitted BSSID sub-element is set to a value from a set of multiple values.

In some implementations, the communications manager 525 is capable of, configured to, or operable to support a means for transmitting the second timing information within a first set of fields of a first information element of the one or more management frames, the first information element being outside of a multiple basic service set (BSS) ID information element. In some implementations, the communications manager 525 is capable of, configured to, or operable to support a means for transmitting respective subsets of the first timing information within respective fields of respective nontransmitted BSSID sub-element of the multiple BSSID information element.

In some implementations, a respective schedule information subfield value of each of the first set of fields is set to a value from a set of multiple values in accordance with the second communication periods corresponding to the first wireless communication device.

In some implementations, each respective nontransmitted BSSID sub-element of the multiple BSSID information element includes a respective subset of the first timing information and excludes a remainder of the first timing information. In some implementations, a schedule information subfield of that respective nontransmitted BSSID sub-element is set to a value from a set of multiple values.

In some implementations, the communications manager 525 is capable of, configured to, or operable to support a means for transmitting the first timing information within a first set of fields of a first information element of the one or more management frames, the first information element being outside of a multiple basic service set (BSS) ID information element. In some implementations, the communications manager 525 is capable of, configured to, or operable to support a means for transmitting the second timing information within a second set of fields of the first information element of the one or more management frames. In some implementations, the communications manager 525 is capable of, configured to, or operable to support a means for transmitting both the first timing information and the second timing information within a third set of one or more fields of each nontransmitted BSSID sub-element of the multiple BSSID information element.

In some implementations, a respective first schedule information subfield value of each of the first set of fields is set to a same value in accordance with the first communication periods corresponding to the set of APs (such as matching to a corresponding AP in the set of APs). In some implementations, a respective schedule information subfield value of each of the second set of fields is set to a value from a set of multiple values in accordance with the second communication periods corresponding to the first wireless communication device.

In some implementations, each respective nontransmitted BSSID sub-element of the multiple BSSID information element includes a first field including a subset of the first timing information of a corresponding nontransmitted BSSID and includes one or more second fields including a remainder of the first timing information and the second timing information. In some implementations, the first field includes a first schedule information subfield value set to a value from a set of multiple values and each of the one or more second fields include a second schedule information subfield value set to a same value.

In some implementations, the first communication periods are active schedules of communication periods that correspond to set of APs.

In some implementations, the communications manager 525 is capable of, configured to, or operable to support a means for changing timing information of the first timing information or the second timing information or one or more states associated with the first communication periods or the second communication periods. In some implementations, the communications manager 525 is capable of, configured to, or operable to support a means for setting a field value in one or more second management frames based on changing the timing information or the one or more states. In some implementations, the communications manager 525 is capable of, configured to, or operable to support a means for transmitting the one or more second management frames in accordance with the field value.

In some implementations, setting the field value is associated with setting a critical update flag to a one value, incrementing a basic service set (BSS) parameter change count, or incrementing a value associated with a check beacon field value.

In some implementations, the field value is dedicated to changes related to protected communication.

In some implementations, the communications manager 525 is capable of, configured to, or operable to support a means for adding the timing information to, or removing the timing information from, the first timing information or the second timing information, where changing the timing information is associated with adding or removing the timing information from the first timing information or the second timing information.

In some implementations, the communications manager 525 is capable of, configured to, or operable to support a means for changing one or more schedule information subfield values corresponding to one or more schedules of communication periods of the first communication periods or the second communication periods, where changing the one or more states is associated with changing the one or more schedule information subfield values.

In some implementations, changing a schedule information subfield values is associated with changing a corresponding schedule of communication periods from active to inactive, inactive to active, open to new members to closed to new members, or closed to new members to open to new members.

In some implementations, the communications manager 525 is capable of, configured to, or operable to support a means for selecting the set of APs as coordinating APs, where the coordination with the first timing information is based on the set of APs being coordinating APs.

In some implementations, the set of APs are selected as coordinating APs in accordance with the set of APs being members of a same extended service set (ESS) as the first wireless communication device.

In some implementations, the communications manager 525 is capable of, configured to, or operable to support a means for communicating an indication of a group ID associated with a set of coordinating APs, where the set of APs are members of the set of coordinating APs in accordance with having a same group ID.

In some implementations, the set of APs are selected as coordinating APs in accordance with the set of APs being associated with a same manufacturer or a same vendor.

In some implementations, the set of APs are selected as coordinating APs in accordance with the set of APs being associated a same anchor AP as the first wireless communication device.

In some implementations, the communications manager 525 is capable of, configured to, or operable to support a means for detecting frame transmissions from the set of APs, where the set of APs are selected as coordinating APs in accordance with detecting the frame transmissions.

In some implementations, the communications manager 525 is capable of, configured to, or operable to support a means for detecting that an AP of the set of APs, or a wireless STA associated with at least one AP of the set of APs, performs a threshold quantity of transmissions during the second communication periods. In some implementations, the communications manager 525 is capable of, configured to, or operable to support a means for removing the AP, or the wireless STA, from the coordination based on detecting that the AP, or the wireless STA, performs the threshold quantity of transmissions during the second communication periods.

In some implementations, the communications manager 525 is capable of, configured to, or operable to support a means for obtaining information indicative of a group of coordinating APs, where the coordination with the first timing information is based on the AP and the set of APs belonging to the group of coordinating APs.

In some implementations, the information indicative of the group of coordinating APs includes scheduling information pertaining to which APs are capable of having overlapped communication periods, which communication periods are to be orthogonal to other communication periods, and rules associated with transmission opportunity (TXOP) sharing during a communication period.

In some implementations, the communications manager 525 is capable of, configured to, or operable to support a means for obtaining a security key for use in communications between the first wireless communication device and other wireless communication devices of the group of coordinating APs.

In some implementations, the communications manager 525 is capable of, configured to, or operable to support a means for communicating one or more coordination frames with at least a subset of the set of APs, where obtaining the first timing information is associated with communicating the one or more coordination frames, and where the one or more coordination frames include security information associated with an authentication of coordinating APs.

In some implementations, the communications manager 525 is capable of, configured to, or operable to support a means for obtaining a transmission opportunity for the first wireless communication device during a communication period of the second communication periods, where obtaining the transmission opportunity during the communication period is associated with prioritized access for the first wireless communication device during the second communication periods.

In some implementations, the prioritized access for the first wireless communication device is associated with one or more quiet intervals to other wireless communication devices or a relatively smaller channel access countdown value as compared to the other wireless communication devices.

In some implementations, the communications manager 525 is capable of, configured to, or operable to support a means for transmitting the first timing information or the second timing information within an information element outside of a target wake time (TWT) information element.

In some implementations, the information element outside of the TWT information element is included in a management frame that follows a beacon frame. In some implementations, the beacon frame indicates that the first timing information or the second timing information is included in the information element included in the management frame that follows the beacon frame.

In some implementations, the beacon frame includes the second timing information and a first subset of the first timing information that pertains to a first set of APs associated with the first wireless communication device and the management frame that follows the beacon frame includes a second subset of the first timing information that pertains to a second set of APs non-collocated with the first wireless communication device. In some implementations, the one or more management frames include the beacon frame and the management frame that follows the beacon frame.

In some implementations, the communications manager 525 is capable of, configured to, or operable to support a means for scheduling the second communication periods based on the first communication periods and one or more periodic transmissions by the first wireless communication device.

In some implementations, to support scheduling the second communication periods, the communications manager 525 is capable of, configured to, or operable to support a means for scheduling the second communication periods such that target beacon transmission times (TBTTs) corresponding to the first wireless communication device are during the second communication periods, the one or more periodic transmissions including periodic beacon transmissions associated with the TBTTs.

In some implementations, the first timing information or the second timing information are expressed on a basis of milliseconds that do not divide evenly into time units (TUs). In some implementations, the first timing information or the second timing information indicate start times of initial communication periods of the first communication periods or the second communication periods based on the first timing information or the second timing information being expressed on the basis of the milliseconds that do not divide evenly into TUs.

In some implementations, the first timing information or the second timing information are expressed on a basis of time units (TUs). In some implementations, the first timing information or the second timing information indicate start times of next communication periods of the first communication periods or the second communication periods based on the first timing information or the second timing information being expressed on the basis of TUs.

In some implementations, the communications manager 525 is capable of, configured to, or operable to support a means for obtaining a request from a second wireless communication device to join a schedule of communication periods of the second communication periods. In some implementations, the communications manager 525 is capable of, configured to, or operable to support a means for transmitting an indication of an alternative schedule of communication periods of the second communication periods.

In some implementations, a device capability of the second wireless communication device is associated with an inability to differentiate between restricted target wake time (R-TWT) parameter sets and broadcast target wake time (b-TWT) parameter sets. In some implementations, the indication of the alternative schedule of communication periods is transmitted based on the device capability.

In some implementations, the first communication periods and the second communication periods are associated with any combination of one or more restricted target wake time (R-TWT) service periods (SPs), one or more TWT epochs, one or more quiet intervals, selective transmission opportunity (TXOP) sharing, or one or more differentiated channel access parameters that prioritize channel access to at least one wireless communication device.

In some implementations, the first wireless communication device is an AP. In some implementations, the set of APs includes a first set of APs associated with the first wireless communication device, a second set of APs non-collocated with the first wireless communication device, or any combination thereof.

In some implementations, the AP and the first set of APs are members of a same multiple basic service set (BSS) ID set or a same co-hosted BSSID set.

In some implementations, the first wireless communication device and the set of APs are members of a same multiple basic service set (BSS) ID (BSSID) set or a same co-hosted BSSID set.

In some implementations, the first communication periods are first protected communication periods associated with first restricted target wake times (R-TWTs). In some implementations, the second communication periods are second protected communication periods associated with second R-TWTs.

In some implementations, the first timing information pertaining to the first communication periods indicates a set of multiple communication schedules, each respective AP of the set of APs corresponding to a respective set of one or more communication schedules of the set of multiple communication schedules. In some implementations, the second timing information pertaining to the second communication periods indicates one or more communication schedules that correspond to the first wireless communication device.

Additionally, or alternatively, the wireless communication device 500 may support wireless communication in accordance with examples as disclosed herein. In some implementations, the communications manager 525 is capable of, configured to, or operable to support a means for communicating a public action frame in accordance with coordinated medium access involving the first wireless communication and at least a second wireless communication device. In some implementations, the communications manager 525 is capable of, configured to, or operable to support a means for communicating with one or more wireless communication devices based on the coordinated medium access.

In some implementations, the information included within the public action frame includes timing information associated with one or more communication periods. In some implementations, the coordinated medium access is associated with the one or more communication periods.

In some implementations, the communications manager 525 is capable of, configured to, or operable to support a means for transmitting a frame associated with a sharing of a transmission opportunity (TXOP) of the first wireless communication device with the second wireless communication device. In some implementations, the communications manager 525 is capable of, configured to, or operable to support a means for receiving the public action frame from the second wireless communication device based on the sharing of the TXOP, where the public action frame indicates a return of a remainder of the TXOP to the first wireless communication device.

In some implementations, the communications manager 525 is capable of, configured to, or operable to support a means for receiving a frame associated with a sharing of a transmission opportunity (TXOP) of the second wireless communication device with the first wireless communication device. In some implementations, the communications manager 525 is capable of, configured to, or operable to support a means for communicating with the one or more wireless communication devices during a portion of the TXOP. In some implementations, the communications manager 525 is capable of, configured to, or operable to support a means for transmitting the public action frame to the second wireless communication device, where the public action frame indicates a return of a remainder of the TXOP to the second wireless communication device.

In some implementations, a medium access control (MAC) header of the public action frame includes information pertaining to the coordinated medium access.

In some implementations, a frame body of the public action frame includes information that pertains to one or more communication links to which the coordinated medium access applies.

In some implementations, a medium access control (MAC) header of the public action frame includes an indication to ignore a frame body of the public action frame and to parse information pertaining to the coordinated medium access from the MAC header.

In some implementations, a receiver address (RA) of the public action frame indicates an ID of the first wireless communication device or the second wireless communication device if the public action frame is transmitted via unicast signaling. In some implementations, the RA of the public action frame indicates a value that addresses multiple APs if the public action frame is transmitted via broadcast signaling, the value that addresses the multiple APs corresponding to a broadcast address specific to wireless communication devices that are capable of the coordinated medium access.

Additionally, or alternatively, the wireless communication device 500 may support wireless communication in accordance with examples as disclosed herein. In some implementations, the communications manager 525 is capable of, configured to, or operable to support a means for assigning an association identifier (AID) to an edge client. In some implementations, the communications manager 525 is capable of, configured to, or operable to support a means for constructing a three-address frame format for one or more data frames to be transmitted toward the edge client or transmitted toward a root AP in accordance with including the AID in the one or more data frames transmitted toward the edge client. In some implementations, the communications manager 525 is capable of, configured to, or operable to support a means for transmitting the one or more data frames in accordance with the three-address frame format.

In some implementations, a data frame is relayed to the edge client via one or more relay devices in accordance with a multi-hop relay path. In some implementations, a receiver address (RA) and a transmitter address (TA) change at each hop of the multi-hop relay path. In some implementations, a relay device immediately upstream of the edge client determines a final RA in accordance with the AID.

In some implementations, the AID is included in an A-Control field of the one or more data frames.

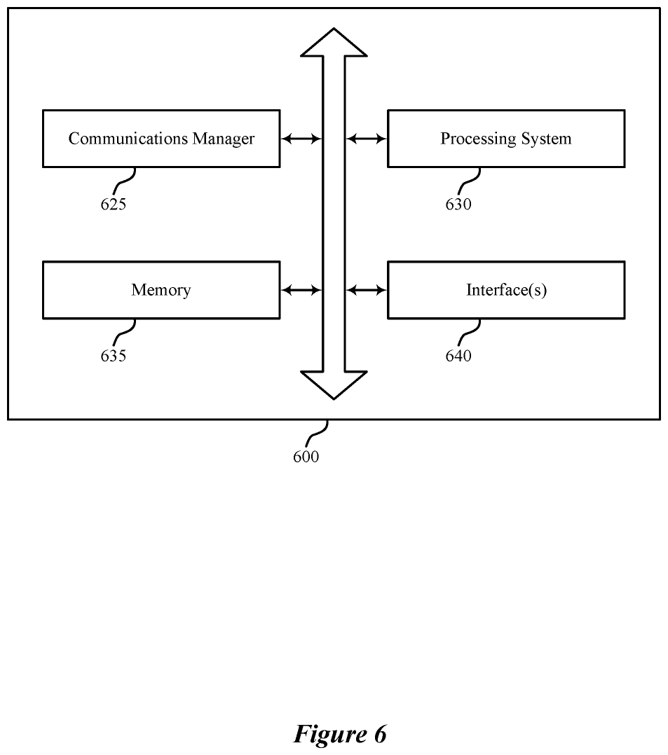

FIG. 6 shows a block diagram of an example wireless communication device 600 that supports techniques for coordinated medium access for ultra-high reliability according to some aspects of the present disclosure. In various examples, the wireless communication device 600 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory” 635).

In some implementations, the wireless communication device 600 can be a device for use in a STA, such as STA 104 described with reference to FIG. 1. In some other examples, the wireless communication device 600 can be a STA that includes such a chip, SoC, chipset, package or device as well as multiple antennas. The wireless communication device 600 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some implementations, the wireless communication device 600 also includes or can be coupled with an application processor which may be further coupled with another memory 635. In some implementations, the wireless communication device 600 further includes a user interface (UI) (such as a touchscreen or keypad) and a display, which may be integrated with the UI to form a touchscreen display. In some implementations, the wireless communication device 600 may further include one or more sensors such as, for example, one or more inertial sensors, accelerometers, temperature sensors, pressure sensors, or altitude sensors.

The wireless communication device 600 includes a communications manager 625. Portions of the communications manager 625 may be implemented at least in part in the hardware or firmware. For example, the communications manager 625 may be implemented at least in part by a modem. In some implementations, the communications manager 625 may be implemented at least in part by a processor and as software stored in memory 635. For example, portions of the communications manager 625 can be implemented as non-transitory instructions (or “code”) executable by the processor to perform the functions or operations of the respective module.

In some implementations, the processor may be a component of a processing system 630. A processing system 630 may generally refer to a system or series of machines or components that receives inputs and processes the inputs to produce a set of outputs (which may be passed to other systems or components of, for example, the wireless communication device 600). For example, a processing system 630 of the wireless communication device 600 may refer to a system including the various other components or subcomponents of the wireless communication device 600, such as the processor, or a transceiver, or a communications manager, or other components or combinations of components of the wireless communication device 600. The processing system 630 of the wireless communication device 600 may interface with other components of the wireless communication device 600, and may process information received from other components (such as inputs or signals) or output information to other components. For example, a chip or modem of the wireless communication device 600 may include a processing system 630, a first interface 640 to output information and a second interface 640 to obtain information. In some implementations, the first interface 640 may refer to an interface between the processing system 630 of the chip or modem and a transmitter, such that the wireless communication device 600 may transmit information output from the chip or modem. In some implementations, the second interface 640 may refer to an interface between the processing system 630 of the chip or modem and a receiver, such that the wireless communication device 600 may obtain information or signal inputs, and the information may be passed to the processing system 630. A person having ordinary skill in the art will readily recognize that the first interface 640 also may obtain information or signal inputs, and the second interface 640 also may output information or signal outputs.

The wireless communication device 600 may support wireless communication in accordance with examples as disclosed herein. The communications manager 625 is capable of, configured to, or operable to support a means for assigning an association identifier (AID) to an edge client. In some implementations, the communications manager 625 is capable of, configured to, or operable to support a means for constructing a three-address frame format for one or more data frames to be transmitted toward the edge client or transmitted toward a root AP in accordance with including the AID in the one or more data frames transmitted toward the edge client. In some implementations, the communications manager 625 is capable of, configured to, or operable to support a means for transmitting the one or more data frames in accordance with the three-address frame format.

In some implementations, a data frame is relayed to the edge client via one or more relay devices in accordance with a multi-hop relay path. In some implementations, a receiver address (RA) and a transmitter address (TA) change at each hop of the multi-hop relay path. In some implementations, a relay device immediately upstream of the edge client determines a final RA in accordance with the AID.

In some implementations, the AID is included in an A-Control field of the one or more data frames.

Additionally, or alternatively, the wireless communication device 600 may support wireless communication in accordance with examples as disclosed herein. In some implementations, the communications manager 625 is capable of, configured to, or operable to support a means for obtaining, based on coordination with first timing information pertaining to first communication periods that correspond to a set of access points (APs), one or more management frames indicating at least second timing information pertaining to second communication periods that correspond to the second wireless communication device, the one or more management frames distinguishing the second communication periods from the first communication periods in accordance with a configured set of identifiers (IDs) that correspond to the first communication periods and the second communication periods. In some implementations, the communications manager 625 is capable of, configured to, or operable to support a means for communicating with the second wireless communication device or a third wireless communication device in accordance with the second communication periods.

In some implementations, the communications manager 625 is capable of, configured to, or operable to support a means for obtaining the first timing information pertaining to the first communication periods, where the set of APs to which the first communication periods correspond are overlapping basic service set (OBSS) APs. In some implementations, the communications manager 625 is capable of, configured to, or operable to support a means for respecting a set of rules associated with the first communication periods.

In some implementations, to support respecting the first communication periods, the communications manager 625 is capable of, configured to, or operable to support a means for terminating a transmission opportunity of the first wireless communication period prior to a start of each of the first communication periods. In some implementations, to support respecting the first communication periods, the communications manager 625 is capable of, configured to, or operable to support a means for following a set of channel access rules within each of the first communication periods.

In some implementations, the communications manager 625 is capable of, configured to, or operable to support a means for obtaining the first timing information within a first set of fields of a first information element of the one or more management frames, where each respective first ID field associated with the first set of fields includes a same ID of the configured set of IDs. In some implementations, the communications manager 625 is capable of, configured to, or operable to support a means for obtaining the second timing information within a second set of fields of the first information element of the one or more management frames, where each respective second ID field associated with the second set of fields includes a unique ID of the configured set of IDs.

In some implementations, each respective first ID field associated with the first set of fields includes the same ID of the configured set of IDs to distinguish the first communication periods as corresponding to one or more overlapping basic service sets (OBSSs). In some implementations, unique IDs for each respective second ID field associated with the second set of fields differentiates the second communication periods into one or more schedules of communication periods of the second wireless communication device.

In some implementations, the communications manager 625 is capable of, configured to, or operable to support a means for obtaining a first subset of the first timing information within a first set of fields of a first information element of the one or more management frames. In some implementations, the communications manager 625 is capable of, configured to, or operable to support a means for obtaining the second timing information within a second set of fields of the first information element of the one or more management frames. In some implementations, the communications manager 625 is capable of, configured to, or operable to support a means for obtaining a second subset of the first timing information within a third set of fields of a second information element of the one or more management frames.

In some implementations, the first subset of the first timing information pertains to a first subset of the first communication periods, the first subset of the first communication periods corresponding to a first set of APs associated with the second wireless communication device. In some implementations, the second subset of the first timing information pertains to a second subset of the first communication periods, the second subset of the first communication periods corresponding to a second set of APs non-collocated with the second wireless communication device.

In some implementations, each respective first ID field associated with the first set of fields and the second set of fields includes a unique ID of the configured set of IDs. In some implementations, each respective second ID field associated with the third set of fields includes a respective identification information corresponding to a respective AP of a second set of APs non-collocated with the second wireless communication device.

In some implementations, the second information element is an extension element. In some implementations, the respective identification information includes respective basic service set (BSS) ID identifying information.

In some implementations, the communications manager 625 is capable of, configured to, or operable to support a means for obtaining the first timing information within a first set of fields of the one or more management frames, where a respective first schedule information subfield value of each of the first set of fields is set to a same value in accordance with the first communication periods corresponding to the set of APs (such as matching to a corresponding AP in the set of APs), the set of APs belonging to a same co-hosted basic service set (BSS) ID set as the second wireless communication device. In some implementations, the communications manager 625 is capable of, configured to, or operable to support a means for obtaining the second timing information within a second set of fields of the one or more management frames, where a respective second schedule information subfield value of each of the second set of fields is set to a value from a set of multiple values in accordance with the second communication periods corresponding to the second wireless communication device.

In some implementations, the respective first schedule information subfield value is a dedicated value of a schedule information field that indicates that a corresponding schedule of communication periods is for one of the set of APs associated with the second wireless communication device. In some implementations, the set of multiple values is a set of values of the schedule information field that indicates that a corresponding schedule of communication periods is for the second wireless communication device.

In some implementations, the communications manager 625 is capable of, configured to, or operable to support a means for obtaining exclusively the second timing information within a set of fields of the one or more management frames, where a respective schedule information subfield value of each of the set of fields is set to a value from a set of multiple values in accordance with the second communication periods corresponding to the second wireless communication device.

In some implementations, the set of multiple values is a set of values of a schedule information field that indicates that a corresponding schedule of communication periods is for the second wireless communication device.

In some implementations, the communications manager 625 is capable of, configured to, or operable to support a means for obtaining the first timing information within a first set of fields of a first information element of the one or more management frames, the first information element being outside of a multiple basic service set (BSS) ID information element. In some implementations, the communications manager 625 is capable of, configured to, or operable to support a means for obtaining the second timing information within a second set of fields of the first information element of the one or more management frames. In some implementations, the communications manager 625 is capable of, configured to, or operable to support a means for obtaining respective subsets of the first timing information within respective fields of respective nontransmitted BSSID sub-elements of the multiple BSSID information element.

In some implementations, a respective first schedule information subfield value of each of the first set of fields is set to a same value in accordance with the first communication periods corresponding to the set of APs (such as matching to a corresponding AP in the set of APs). In some implementations, a respective schedule information subfield value of each of the second set of fields is set to a value from a set of multiple values in accordance with the second communication periods corresponding to the second wireless communication device.

In some implementations, each respective nontransmitted BSSID sub-element of the multiple BSSID information element includes a respective subset of the first timing information and excludes a remainder of the first timing information. In some implementations, a schedule information subfield of that respective nontransmitted BSSID sub-element is set to a value from a set of multiple values.

In some implementations, the first wireless communication device parses the first information element and ignores the multiple BSSID information element in accordance with the first wireless communication device being associated with the second wireless communication device, the second wireless communication device being associated with a transmitted BSSID.

In some implementations, the first wireless communication device parses the first information element and parses a nontransmitted BSSID sub-element of the multiple BSSID information element corresponding to an AP of the set of APs in accordance with the first wireless communication device being associated with the AP, the AP being associated with a nontransmitted BSSID.

In some implementations, the communications manager 625 is capable of, configured to, or operable to support a means for obtaining the second timing information within a first set of fields of a first information element of the one or more management frames, the first information element being outside of a multiple basic service set (BSS) ID information element. In some implementations, the communications manager 625 is capable of, configured to, or operable to support a means for obtaining respective subsets of the first timing information within respective fields of respective nontransmitted BSSID sub-elements of the multiple BSSID information element.

In some implementations, a respective schedule information subfield value of each of the first set of fields is set to a value from a set of multiple values in accordance with the second communication periods corresponding to the second wireless communication device.

In some implementations, each respective nontransmitted BSSID sub-element of the multiple BSSID information element includes a respective subset of the first timing information and excludes a remainder of the first timing information. In some implementations, a schedule information subfield of that respective nontransmitted BSSID sub-element is set to a value from a set of multiple values.

In some implementations, the first wireless communication device parses the first information element and parses each respective nontransmitted BSSID sub-element of the multiple BSSID information element in accordance with the first wireless communication device being associated with any AP of a multiple BSSID set associated with the multiple BSSID information element.

In some implementations, the communications manager 625 is capable of, configured to, or operable to support a means for obtaining the first timing information within a first set of fields of a first information element of the one or more management frames, the first information element being outside of a multiple basic service set (BSS) ID information element. In some implementations, the communications manager 625 is capable of, configured to, or operable to support a means for obtaining the second timing information within a second set of fields of the first information element of the one or more management frames. In some implementations, the communications manager 625 is capable of, configured to, or operable to support a means for obtaining both the first timing information and the second timing information within a third set of one or more fields of each nontransmitted BSSID sub-element of the multiple BSSID information element.

In some implementations, a respective first schedule information subfield value of each of the first set of fields is set to a same value in accordance with the first communication periods corresponding to the set of APs (such as matching to a corresponding AP in the set of APs). In some implementations, a respective schedule information subfield value of each of the second set of fields is set to a value from a set of multiple values in accordance with the second communication periods corresponding to the second wireless communication device.

In some implementations, each respective nontransmitted BSSID sub-element of the multiple BSSID information element includes a first field including a subset of the first timing information of a corresponding nontransmitted BSSID and includes one or more second fields including a remainder of the first timing information and the second timing information. In some implementations, the first field includes a first schedule information subfield value set to a value from a set of multiple values and each of the one or more second fields include a second schedule information subfield value set to a same value.

In some implementations, the first wireless communication device parses the first information element and ignores the multiple BSSID information element in accordance with the first wireless communication device being associated with the second wireless communication device, the second wireless communication device being associated with a transmitted BSSID.

In some implementations, the first wireless communication device ignores the first information element and parses a nontransmitted BSSID sub-element of the multiple BSSID information element corresponding to an AP of the set of APs in accordance with the first wireless communication device being associated with the AP, the AP being associated with a nontransmitted BSSID.

In some implementations, the first communication periods are active schedules of communication periods that correspond to the set of APs.

In some implementations, the communications manager 625 is capable of, configured to, or operable to support a means for obtaining one or more second management frames. In some implementations, the communications manager 625 is capable of, configured to, or operable to support a means for detecting a change to timing information of the first timing information or the second timing information or to one or more states associated with the first communication periods or the second communication periods based on a field value in the one or more second management frames.

In some implementations, the field value is associated with a critical update flag having a one value, an increment to a basic service set (BSS) parameter change count, or an increment to a value associated with a check beacon field value.

In some implementations, the field value is dedicated to changes related to protected communication.

In some implementations, a change to a state is associated with a change of a schedule of communication periods from active to inactive, inactive to active, open to new members to closed to new members, or closed to new members to open to new members.

In some implementations, the communications manager 625 is capable of, configured to, or operable to support a means for accessing a wireless channel during a communication period of the second communication periods based on prioritized access for the first wireless communication device during the second communication periods.

In some implementations, the prioritized access for the first wireless communication device is associated with one or more quiet intervals to other wireless communication devices or a relatively smaller channel access countdown value as compared to the other wireless communication devices.

In some implementations, the communications manager 625 is capable of, configured to, or operable to support a means for obtaining the first timing information or the second timing information within an information element outside of a target wake time (TWT) information element.

In some implementations, the information element outside of the TWT information element is included in a management frame that follows a beacon frame. In some implementations, the beacon frame indicates that the first timing information or the second timing information is included in the information element included in the management frame that follows the beacon frame.

In some implementations, the beacon frame includes the second timing information and a first subset of the first timing information that pertains to a first set of APs associated with the second wireless communication device and the management frame that follows the beacon frame includes a second subset of the first timing information that pertains to a second set of APs non-collocated with the second wireless communication device. In some implementations, the one or more management frames include the beacon frame and the management frame that follows the beacon frame.

In some implementations, the first timing information or the second timing information are expressed on a basis of milliseconds that do not divide evenly into time units (TUs). In some implementations, the first timing information or the second timing information indicate start times of initial communication periods of the first communication periods or the second communication periods based on the first timing information or the second timing information being expressed on the basis of the milliseconds that do not divide evenly into TUs.

In some implementations, the first timing information or the second timing information are expressed on a basis of time units (TUs). In some implementations, the first timing information or the second timing information indicate start times of next communication periods of the first communication periods or the second communication periods based on the first timing information or the second timing information being expressed on the basis of TUs.

In some implementations, the communications manager 625 is capable of, configured to, or operable to support a means for transmitting a request to join a schedule of communication periods of the second communication periods. In some implementations, the communications manager 625 is capable of, configured to, or operable to support a means for obtaining an indication of an alternative schedule of communication periods of the second communication periods.

In some implementations, a device capability of the first wireless communication device is associated with an inability to differentiate between restricted target wake time (R-TWT) parameter sets and broadcast target wake time (b-TWT) parameter sets. In some implementations, the indication of the alternative schedule of communication periods is obtained based on the device capability.

In some implementations, the first communication periods and the second communication periods are associated with any combination of one or more restricted target wake time (R-TWT) service periods (SPs), one or more TWT epochs, one or more quiet intervals, selective transmission opportunity (TXOP) sharing, or one or more differentiated channel access parameters that prioritize channel access to at least one wireless communication device.

In some implementations, the first wireless communication device is a wireless STA and the second wireless communication device is an AP.

In some implementations, the set of APs includes a first set of APs associated with the first wireless communication device, a second set of APs non-collocated with the first wireless communication device, or any combination thereof. In some implementations, the AP and the first set of APs are members of a same multiple basic service set (BSS) ID set or a same co-hosted BSSID set.

In some implementations, the second wireless communication device and the set of APs are members of a same multiple basic service set (BSS) ID (BSSID) set or a same co-hosted BSSID set.

In some implementations, the first communication periods are first protected communication periods associated with first restricted target wake times (R-TWTs). In some implementations, the second communication periods are second protected communication periods associated with second R-TWTs.

In some implementations, the first timing information pertaining to the first communication periods indicates a set of multiple communication schedules, each respective AP of the set of APs corresponding to a respective set of one or more communication schedules of the set of multiple communication schedules. In some implementations, the second timing information pertaining to the second communication periods indicates one or more communication schedules that correspond to the second wireless communication device.

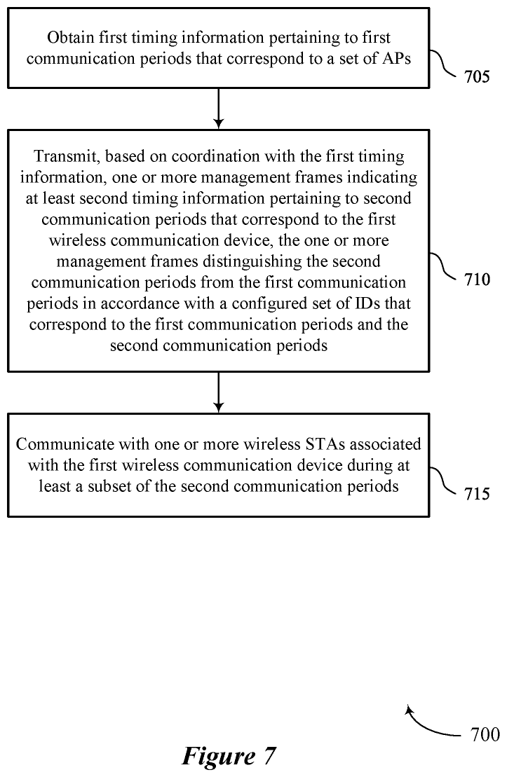

FIG. 7 shows a flowchart illustrating an example process 700 performable at a wireless AP that supports techniques for coordinated medium access for ultra-high reliability according to some aspects of the present disclosure. The operations of the process 700 may be an example of a method implemented by a wireless AP or its components as described herein. For example, the process 700 may be performed by a wireless communication device, such as the wireless communication device 500 described with reference to FIG. 5, operating as or within a wireless AP. In some implementations, the process 700 may be performed by a wireless AP, such as one of the APs 102 described with reference to FIG. 1.

In some implementations, in block 705, the wireless AP may obtain first timing information pertaining to first communication periods that correspond to a set of APs. The operations of block 705 may be performed in accordance with examples as disclosed herein. In some implementations, aspects of the operations of block 705 may be performed by a communications manager 525 as described with reference to FIG. 5.

In some implementations, in block 710, the wireless AP may transmit, based on coordination with the first timing information, one or more management frames indicating at least second timing information pertaining to second communication periods that correspond to the first wireless communication device, the one or more management frames distinguishing the second communication periods from the first communication periods in accordance with a configured set of IDs that correspond to the first communication periods and the second communication periods. The operations of block 710 may be performed in accordance with examples as disclosed herein. In some implementations, aspects of the operations of block 710 may be performed by a communications manager 525 as described with reference to FIG. 5.

In some implementations, in block 715, the wireless AP may communicate with one or more wireless STAs associated with the first wireless communication device during at least a subset of the second communication periods. The operations of block 715 may be performed in accordance with examples as disclosed herein. In some implementations, aspects of the operations of block 715 may be performed by a communications manager 525 as described with reference to FIG. 5.

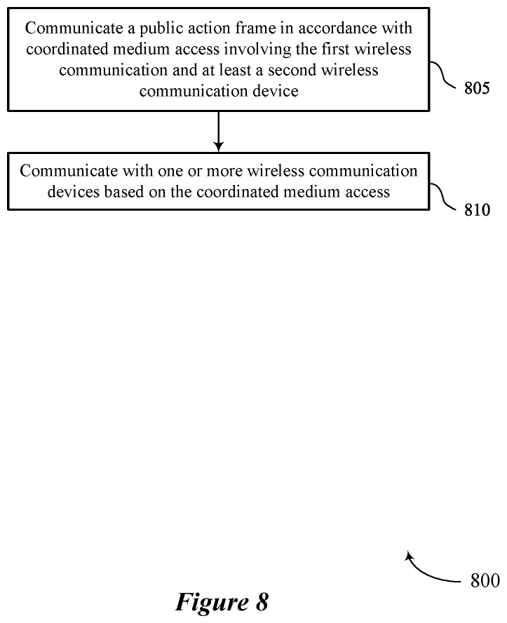

FIG. 8 shows a flowchart illustrating an example process 800 performable at a wireless AP that supports techniques for coordinated medium access for ultra-high reliability according to some aspects of the present disclosure. The operations of the process 800 may be an example of a method implemented by a wireless AP or its components as described herein. For example, the process 800 may be performed by a wireless communication device, such as the wireless communication device 500 described with reference to FIG. 5, operating as or within a wireless AP. In some implementations, the process 800 may be performed by a wireless AP, such as one of the APs 102 described with reference to FIG. 1.

In some implementations, in block 805, the wireless AP may communicate a public action frame in accordance with coordinated medium access involving the first wireless communication and at least a second wireless communication device. The operations of block 805 may be performed in accordance with examples as disclosed herein. In some implementations, aspects of the operations of block 805 may be performed by a communications manager 525 as described with reference to FIG. 5.

In some implementations, in block 810, the wireless AP may communicate with one or more wireless communication devices based on the coordinated medium access. The operations of block 810 may be performed in accordance with examples as disclosed herein. In some implementations, aspects of the operations of block 810 may be performed by a communications manager 525 as described with reference to FIG. 5.

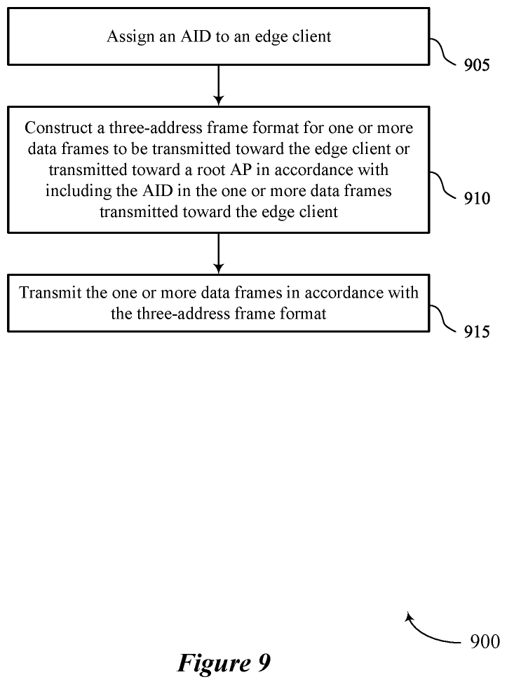

FIG. 9 shows a flowchart illustrating a process 900 performable at a wireless AP or a wireless STA that supports techniques for coordinated medium access for ultra-high reliability in accordance with one or more aspects of the present disclosure. The operations of the process 900 may be implemented by an AP or a STA or its components as described herein. For example, the operations of the process 900 may be performed by an AP or a STA as described with reference to FIGS. 1-6. In some implementations, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

In some implementations, in block 905, the wireless AP or the wireless STA may assign an AID to an edge client. The operations of block 905 may be performed in accordance with examples as disclosed herein. In some implementations, aspects of the operations of block 905 may be performed by a communications manager 525 or a communications manager 625 as described with reference to FIGS. 5 and 6.

In some implementations, in block 910, the wireless AP or the wireless STA may construct a three-address frame format for one or more data frames to be transmitted toward the edge client or transmitted toward a root AP in accordance with including the AID in the one or more data frames transmitted toward the edge client. The operations of block 910 may be performed in accordance with examples as disclosed herein. In some implementations, aspects of the operations of block 910 may be performed by a communications manager 525 or a communications manager 625 as described with reference to FIGS. 5 and 6.

In some implementations, in block 915, the wireless AP or the wireless STA may transmit the one or more data frames in accordance with the three-address frame format. The operations of block 915 may be performed in accordance with examples as disclosed herein. In some implementations, aspects of the operations of block 915 may be performed by a communications manager 525 or a communications manager 625 as described with reference to FIGS. 5 and 6.

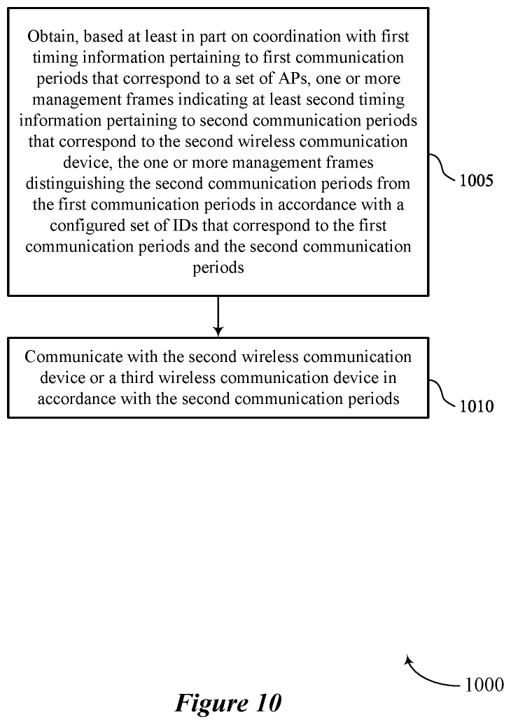

FIG. 10 shows a flowchart illustrating an example process 1000 performable at a wireless STA that supports techniques for coordinated medium access for ultra-high reliability according to some aspects of the present disclosure. The operations of the process 1000 may be an example of a method implemented by a wireless STA or its components as described herein. For example, the process 1000 may be performed by a wireless communication device, such as the wireless communication device 600 described with reference to FIG. 6, operating as or within a wireless STA. In some implementations, the process 1000 may be performed by a wireless STA, such as one of the STAs 104 described with reference to FIG. 1.

In some implementations, in block 1005, the wireless STA may obtain, based at least in part on coordination with first timing information pertaining to first communication periods that correspond to a set of APs, one or more management frames indicating at least second timing information pertaining to second communication periods that correspond to the second wireless communication device, the one or more management frames distinguishing the second communication periods from the first communication periods in accordance with a configured set of IDs that correspond to the first communication periods and the second communication periods. The operations of block 1005 may be performed in accordance with examples as disclosed herein. In some implementations, aspects of the operations of block 1005 may be performed by a communications manager 625 as described with reference to FIG. 6.

In some implementations, in block 1010, the wireless STA may communicate with the second wireless communication device or a third wireless communication device in accordance with the second communication periods. The operations of block 1010 may be performed in accordance with examples as disclosed herein. In some implementations, aspects of the operations of block 1010 may be performed by a communications manager 625 as described with reference to FIG. 6.

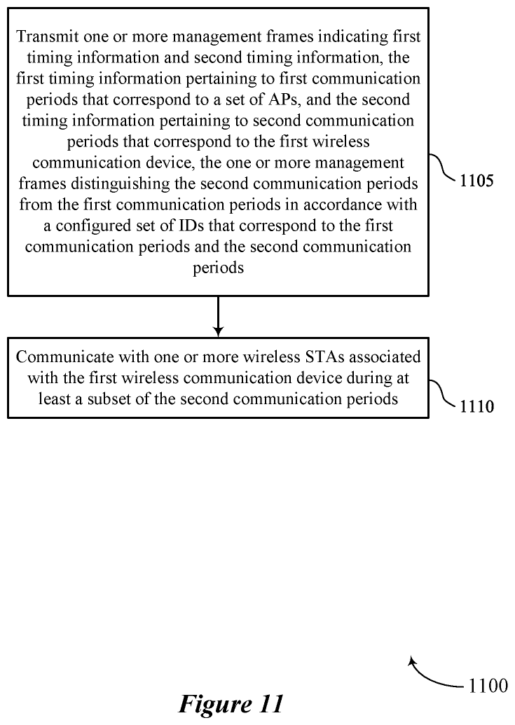

FIG. 11 shows a flowchart illustrating an example process 1100 performable at a wireless AP that supports techniques for coordinated medium access for ultra-high reliability according to some aspects of the present disclosure. The operations of the process 1100 may be an example of a method implemented by a wireless AP or its components as described herein. For example, the process 1100 may be performed by a wireless communication device, such as the wireless communication device 500 described with reference to FIG. 5, operating as or within a wireless AP. In some implementations, the process 1100 may be performed by a wireless AP, such as one of the APs 102 described with reference to FIG. 1.

In some implementations, in block 1105, the wireless AP may transmit one or more management frames indicating first timing information and second timing information, the first timing information pertaining to first communication periods that correspond to a set of APs, and the second timing information pertaining to second communication periods that correspond to the first wireless communication device, the one or more management frames distinguishing the second communication periods from the first communication periods in accordance with a configured set of IDs that correspond to the first communication periods and the second communication periods. The operations of block 1105 may be performed in accordance with examples as disclosed herein. In some implementations, aspects of the operations of block 1105 may be performed by a communications manager 525 as described with reference to FIG. 5.

In some implementations, in block 1110, the wireless AP may communicate with one or more wireless STAs associated with the first wireless communication device during at least a subset of the second communication periods. The operations of block 1110 may be performed in accordance with examples as disclosed herein. In some implementations, aspects of the operations of block 1110 may be performed by a communications manager 525 as described with reference to FIG. 5.

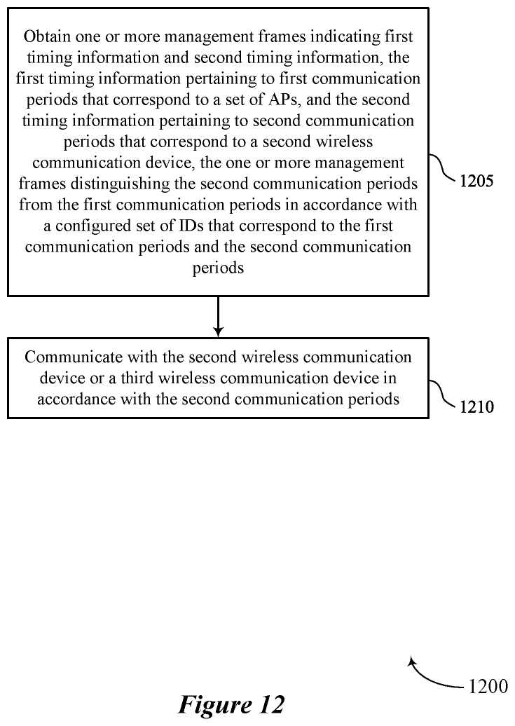

FIG. 12 shows a flowchart illustrating an example process 1200 performable at a wireless STA that supports techniques for coordinated medium access for ultra-high reliability according to some aspects of the present disclosure. The operations of the process 1200 may be an example of a method implemented by a wireless STA or its components as described herein. For example, the process 1200 may be performed by a wireless communication device, such as the wireless communication device 600 described with reference to FIG. 6, operating as or within a wireless STA. In some implementations, the process 1200 may be performed by a wireless STA, such as one of the STAs 104 described with reference to FIG. 1.

In some implementations, in block 1205, the wireless STA may obtain one or more management frames indicating first timing information and second timing information, the first timing information pertaining to first communication periods that correspond to a set of APs, and the second timing information pertaining to second communication periods that correspond to a second wireless communication device, the one or more management frames distinguishing the second communication periods from the first communication periods in accordance with a configured set of IDs that correspond to the first communication periods and the second communication periods. The operations of block 1205 may be performed in accordance with examples as disclosed herein. In some implementations, aspects of the operations of block 1205 may be performed by a communications manager 625 as described with reference to FIG. 6.

In some implementations, in block 1210, the wireless STA may communicate with the second wireless communication device or a third wireless communication device in accordance with the second communication periods. The operations of block 1210 may be performed in accordance with examples as disclosed herein. In some implementations, aspects of the operations of block 1210 may be performed by a communications manager 625 as described with reference to FIG. 6.

Implementation examples are described in the following numbered clauses:

Clause 1: A method for wireless communication performable at a first wireless communication device, comprising: obtaining first timing information pertaining to first communication periods that correspond to a set of access points (APs); transmitting, based at least in part on coordination with the first timing information, one or more management frames indicating at least second timing information pertaining to second communication periods that correspond to the first wireless communication device, the one or more management frames distinguishing the second communication periods from the first communication periods in accordance with a configured set of identifiers (IDs) that correspond to the first communication periods and the second communication periods; and communicating with one or more wireless stations (STAs) associated with the first wireless communication device during at least a subset of the second communication periods.

Clause 2: The method of clause 1, further comprising: transmitting the first timing information within a first set of fields of a first information element of the one or more management frames, wherein each respective first ID field associated with the first set of fields includes a same ID of the configured set of IDs; and transmitting the second timing information within a second set of fields of the first information element of the one or more management frames, wherein each respective second ID field associated with the second set of fields includes a unique ID of the configured set of IDs.

Clause 3: The method of clause 2, wherein each respective first ID field associated with the first set of fields includes the same ID of the configured set of IDs to distinguish the first communication periods as corresponding to one or more overlapping basic service sets (OBSSs), and unique IDs for each respective second ID field associated with the second set of fields differentiates the second communication periods into one or more schedules of communication periods of the first wireless communication device.

Clause 4: The method of any of clauses 2-3, wherein the first wireless communication device is a restricted target wake time (R-TWT) scheduling AP that is announcing an R-TWT schedule with a restricted TWT schedule information subfield value set to three, and the R-TWT scheduling AP is to set a broadcast TWT ID subfield to a fixed value in a broadcast TWT field corresponding to the R-TWT schedule in accordance with announcing the R-TWT schedule with the restricted TWT schedule information subfield set to three.

Clause 5: The method of any of clauses 1-4, further comprising: transmitting a first subset of the first timing information within a first set of fields of a first information element of the one or more management frames; transmitting the second timing information within a second set of fields of the first information element of the one or more management frames; and transmitting a second subset of the first timing information within a third set of fields of a second information element of the one or more management frames.

Clause 6: The method of clause 5, wherein the first subset of the first timing information pertains to a first subset of the first communication periods, the first subset of the first communication periods corresponding to a first set of APs associated with the first wireless communication device, and the second subset of the first timing information pertains to a second subset of the first communication periods, the second subset of the first communication periods corresponding to a second set of APs non-collocated with the first wireless communication device.

Clause 7: The method of any of clauses 5-6, wherein each respective first ID field associated with the first set of fields and the second set of fields includes a unique ID of the configured set of IDs, and each respective second ID field associated with the third set of fields includes respective identification information corresponding to a respective AP of a second set of APs non-collocated with the first wireless communication device.

Clause 8: The method of clause 7, wherein the second information element is an extension element, and the respective identification information comprises respective basic service set (BSS) ID identifying information.

Clause 9: The method of any of clauses 1-8, further comprising: transmitting the first timing information within a first set of fields of the one or more management frames, wherein a respective first schedule information subfield value of each of the first set of fields is set to a same value in accordance with the first communication periods corresponding to the set of APs, the set of APs belonging to a same co-hosted basic service set (BSS) ID set as the first wireless communication device; and transmitting the second timing information within a second set of fields of the one or more management frames, wherein a respective second schedule information subfield value of each of the second set of fields is set to a value from a set of multiple values in accordance with the second communication periods corresponding to the first wireless communication device.

Clause 10: The method of clause 9, wherein the respective first schedule information subfield value is a dedicated value of a schedule information field that indicates that a corresponding schedule of communication periods is for one of the set of APs, and the set of multiple values is a set of values of the schedule information field that indicates that a corresponding schedule of communication periods is for the first wireless communication device.

Clause 11: The method of any of clauses 1-10, further comprising: transmitting exclusively the second timing information within a set of fields of the one or more management frames, wherein a respective schedule information subfield value of each of the set of fields is set to a value from a set of multiple values in accordance with the second communication periods corresponding to the first wireless communication device; and excluding the first timing information from the one or more management frames in accordance with the first communication periods corresponding to the set of APs, the set of APs belonging to a same co-hosted basic service set (BSS) ID set as the first wireless communication device.

Clause 12: The method of clause 11, wherein the set of multiple values is a set of values of a schedule information field that indicates that a corresponding schedule of communication periods is for the first wireless communication device.

Clause 13: The method of any of clauses 1-12, further comprising: transmitting the first timing information within a first set of fields of a first information element of the one or more management frames, the first information element being outside of a multiple basic service set (BSS) ID information element; transmitting the second timing information within a second set of fields of the first information element of the one or more management frames; and transmitting respective subsets of the first timing information within respective fields of respective non-transmitted BSSID sub-element of the multiple BSSID information element.

Clause 14: The method of clause 13, wherein a respective first schedule information subfield value of each of the first set of fields is set to a same value in accordance with the first communication periods corresponding to the set of APs, and a respective schedule information subfield value of each of the second set of fields is set to a value from a set of multiple values in accordance with the second communication periods corresponding to the first wireless communication device.

Clause 15: The method of any of clauses 13-14, wherein each respective non-transmitted BSSID sub-element of the multiple BSSID information element includes a respective subset of the first timing information and excludes a remainder of the first timing information, and a schedule information subfield of that respective non-transmitted BSSID sub-element is set to a value from a set of multiple values.

Clause 16: The method of any of clauses 1-15, further comprising: transmitting the second timing information within a first set of fields of a first information element of the one or more management frames, the first information element being outside of a multiple basic service set (BSS) ID information element; and transmitting respective subsets of the first timing information within respective fields of respective non-transmitted BSSID sub-element of the multiple BSSID information element.

Clause 17: The method of clause 16, wherein a respective schedule information subfield value of each of the first set of fields is set to a value from a set of multiple values in accordance with the second communication periods corresponding to the first wireless communication device.

Clause 18: The method of any of clauses 16-17, wherein each respective non-transmitted BSSID sub-element of the multiple BSSID information element includes a respective subset of the first timing information and excludes a remainder of the first timing information, and a schedule information subfield of that respective non-transmitted BSSID sub-element is set to a value from a set of multiple values.

Clause 19: The method of any of clauses 1-18, further comprising: transmitting the first timing information within a first set of fields of a first information element of the one or more management frames, the first information element being outside of a multiple basic service set (BSS) ID information element; transmitting the second timing information within a second set of fields of the first information element of the one or more management frames; and transmitting both the first timing information and the second timing information within a third set of one or more fields of each non-transmitted BSSID sub-element of the multiple BSSID information element.

Clause 20: The method of clause 19, wherein a respective first schedule information subfield value of each of the first set of fields is set to a same value in accordance with the first communication periods corresponding to the set of APs, and a respective schedule information subfield value of each of the second set of fields is set to a value from a set of multiple values in accordance with the second communication periods corresponding to the first wireless communication device.

Clause 21: The method of any of clauses 19-20, wherein each respective non-transmitted BSSID sub-element of the multiple BSSID information element includes a first field including a subset of the first timing information of a corresponding non-transmitted BSSID and includes one or more second fields including a remainder of the first timing information and the second timing information, and the first field includes a first schedule information subfield value set to a value from a set of multiple values and each of the one or more second fields include a second schedule information subfield value set to a same value.

Clause 22: The method of any of clauses 1-21, wherein the first communication periods are active schedules of communication periods that correspond to set of APs.

Clause 23: The method of any of clauses 1-22, further comprising: changing timing information of the first timing information or the second timing information or one or more states associated with the first communication periods or the second communication periods; setting a field value in one or more second management frames based at least in part on changing the timing information or the one or more states; and transmitting the one or more second management frames in accordance with the field value.

Clause 24: The method of clause 23, wherein setting the field value is associated with setting a critical update flag to a one value, incrementing a basic service set (BSS) parameter change count, or incrementing a value associated with a check beacon field value.

Clause 25: The method of any of clauses 23-24, wherein the field value is dedicated to changes related to protected communication.

Clause 26: The method of any of clauses 23-25, further comprising: adding the timing information to, or removing the timing information from, the first timing information or the second timing information, wherein changing the timing information is associated with adding or removing the timing information from the first timing information or the second timing information.

Clause 27: The method of any of clauses 23-26, further comprising: changing one or more schedule information subfield values corresponding to one or more schedules of communication periods of the first communication periods or the second communication periods, wherein changing the one or more states is associated with changing the one or more schedule information subfield values.

Clause 28: The method of clause 27, wherein changing a schedule information subfield values is associated with changing a corresponding schedule of communication periods from active to inactive, inactive to active, open to new members to closed to new members, or closed to new members to open to new members.

Clause 29: The method of any of clauses 1-28, further comprising: selecting the set of APs as coordinating APs, wherein the coordination with the first timing information is based at least in part on the set of APs being coordinating APs.

Clause 30: The method of clause 29, wherein the set of APs are selected as coordinating APs in accordance with the set of APs being members of a same extended service set (ESS) as the first wireless communication device.

Clause 31: The method of any of clauses 29-30, further comprising: communicating an indication of a group ID associated with a set of coordinating APs, wherein the set of APs are members of the set of coordinating APs in accordance with having a same group ID.

Clause 32: The method of any of clauses 29-31, wherein the set of APs are selected as coordinating APs in accordance with the set of APs being associated with a same manufacturer or a same vendor.

Clause 33: The method of any of clauses 29-32, wherein the set of APs are selected as coordinating APs in accordance with the set of APs being associated a same anchor AP as the first wireless communication device.

Clause 34: The method of any of clauses 29-33, further comprising: detecting frame transmissions from the set of APs, wherein the set of APs are selected as coordinating APs in accordance with detecting the frame transmissions.

Clause 35: The method of clause 34, further comprising: detecting that an AP of the set of APs, or a wireless STA associated with at least one AP of the set of APs, performs a threshold quantity of transmissions during the second communication periods; and removing the AP, or the wireless STA, from the coordination based at least in part on detecting that the AP, or the wireless STA, performs the threshold quantity of transmissions during the second communication periods.

Clause 36: The method of any of clauses 1-35, further comprising: obtaining information indicative of a group of coordinating APs, wherein the coordination with the first timing information is based at least in part on the AP and the set of APs belonging to the group of coordinating APs.

Clause 37: The method of clause 36, wherein the information indicative of the group of coordinating APs includes scheduling information pertaining to which APs are capable of having overlapped communication periods, which communication periods are to be orthogonal to other communication periods, and rules associated with transmission opportunity (TXOP) sharing during a communication period.

Clause 38: The method of any of clauses 36-37, further comprising: obtaining a security key for use in communications between the first wireless communication device and other wireless communication devices of the group of coordinating APs.

Clause 39: The method of any of clauses 1-38, further comprising: communicating one or more coordination frames with at least a subset of the set of APs, wherein obtaining the first timing information is associated with communicating the one or more coordination frames, and wherein the one or more coordination frames include security information associated with an authentication of coordinating APs.

Clause 40: The method of any of clauses 1-39, further comprising: obtaining a transmission opportunity for the first wireless communication device during a communication period of the second communication periods, wherein obtaining the transmission opportunity during the communication period is associated with prioritized access for the first wireless communication device during the second communication periods.

Clause 41: The method of clause 40, wherein the prioritized access for the first wireless communication device is associated with one or more quiet intervals to other wireless communication devices or a relatively smaller channel access countdown value as compared to the other wireless communication devices.

Clause 42: The method of any of clauses 1-41, further comprising: transmitting the first timing information or the second timing information within an information element outside of a target wake time (TWT) information element.

Clause 43: The method of clause 42, wherein the information element outside of the TWT information element is included in a management frame that follows a beacon frame, and the beacon frame indicates that the first timing information or the second timing information is included in the information element included in the management frame that follows the beacon frame.

Clause 44: The method of clause 43, wherein the beacon frame includes the second timing information and a first subset of the first timing information that pertains to a first set of APs associated with the first wireless communication device and the management frame that follows the beacon frame includes a second subset of the first timing information that pertains to a second set of APs non-collocated with the first wireless communication device, and the one or more management frames include the beacon frame and the management frame that follows the beacon frame.

Clause 45: The method of any of clauses 1-44, further comprising: scheduling the second communication periods based at least in part on the first communication periods and one or more periodic transmissions by the first wireless communication device.

Clause 46: The method of clause 45, wherein scheduling the second communication periods comprises: scheduling the second communication periods such that target beacon transmission times (TBTTs) corresponding to the first wireless communication device are during the second communication periods, the one or more periodic transmissions including periodic beacon transmissions associated with the TBTTs.

Clause 47: The method of any of clauses 1-46, wherein the first timing information or the second timing information are expressed on a basis of milliseconds that do not divide evenly into time units (TUs), and the first timing information or the second timing information indicate start times of initial communication periods of the first communication periods or the second communication periods based at least in part on the first timing information or the second timing information being expressed on the basis of the milliseconds that do not divide evenly into TUs.

Clause 48: The method of any of clauses 1-47, wherein the first timing information or the second timing information are expressed on a basis of time units (TUs), and the first timing information or the second timing information indicate start times of next communication periods of the first communication periods or the second communication periods based at least in part on the first timing information or the second timing information being expressed on the basis of TUs.

Clause 49: The method of any of clauses 1-48, further comprising: obtaining a request from a second wireless communication device to join a schedule of communication periods of the second communication periods; and transmitting an indication of an alternative schedule of communication periods of the second communication periods.

Clause 50: The method of clause 49, wherein a device capability of the second wireless communication device is associated with an inability to differentiate between restricted target wake time (R-TWT) parameter sets and broadcast target wake time (b-TWT) parameter sets, and the indication of the alternative schedule of communication periods is transmitted based at least in part on the device capability.

Clause 51: The method of any of clauses 1-50, wherein the first communication periods and the second communication periods are associated with any combination of one or more restricted target wake time (R-TWT) service periods (SPs), one or more TWT epochs, one or more quiet intervals, selective transmission opportunity (TXOP) sharing, or one or more differentiated channel access parameters that prioritize channel access to at least one wireless communication device.

Clause 52: The method of any of clauses 1-51, wherein the first wireless communication device is an AP, and the set of APs includes a first set of APs associated with the first wireless communication device, a second set of APs non-collocated with the first wireless communication device, or any combination thereof.

Clause 53: The method of clause 52, wherein the AP and the first set of APs are members of a same multiple basic service set (BSS) ID set or a same co-hosted BSSID set.

Clause 54: The method of any of clauses 1-53, wherein the first communication periods are first protected communication periods associated with first restricted target wake times (R-TWTs), and the second communication periods are second protected communication periods associated with second R-TWTs.

Clause 55: A method for wireless communication performable at a first wireless communication device, comprising: communicating a public action frame in accordance with coordinated medium access involving the first wireless communication and at least a second wireless communication device; and communicating with one or more wireless communication devices based at least in part on the coordinated medium access.

Clause 56: The method of clause 55, wherein the information included within the public action frame comprises timing information associated with one or more communication periods, and the coordinated medium access is associated with the one or more communication periods.

Clause 57: The method of any of clauses 55-56, further comprising: transmitting a frame associated with a sharing of a transmission opportunity (TXOP) of the first wireless communication device with the second wireless communication device; and receiving the public action frame from the second wireless communication device based at least in part on the sharing of the TXOP, wherein the public action frame indicates a return of a remainder of the TXOP to the first wireless communication device.

Clause 58: The method of any of clauses 55-57, further comprising: receiving a frame associated with a sharing of a transmission opportunity (TXOP) of the second wireless communication device with the first wireless communication device; communicating with the one or more wireless communication devices during a portion of the TXOP; and transmitting the public action frame to the second wireless communication device, wherein the public action frame indicates a return of a remainder of the TXOP to the second wireless communication device.

Clause 59: The method of any of clauses 55-58, wherein a medium access control (MAC) header of the public action frame includes information pertaining to the coordinated medium access.

Clause 60: The method of any of clauses 55-59, wherein a frame body of the public action frame includes information that pertains to one or more communication links to which the coordinated medium access applies.

Clause 61: The method of any of clauses 55-60, wherein a medium access control (MAC) header of the public action frame includes an indication to ignore a frame body of the public action frame and to parse information pertaining to the coordinated medium access from the MAC header.

Clause 62: The method of any of clauses 55-61, wherein a receiver address (RA) of the public action frame indicates an ID of the first wireless communication device or the second wireless communication device if the public action frame is transmitted via unicast signaling, and the RA of the public action frame indicates a value that addresses multiple APs if the public action frame is transmitted via broadcast signaling, the value that addresses the multiple APs corresponding to a broadcast address specific to wireless communication devices that are capable of the coordinated medium access.

Clause 63: A method for wireless communication performable at a first wireless communication device, comprising: assigning an association identifier (AID) to an edge client; constructing a three-address frame format for one or more data frames to be transmitted toward the edge client or transmitted toward a root AP in accordance with including the AID in the one or more data frames transmitted toward the edge client; and transmitting the one or more data frames in accordance with the three-address frame format.

Clause 64: The method of clause 63, wherein a data frame is relayed to the edge client via one or more relay devices in accordance with a multi-hop relay path, a receiver address (RA) and a transmitter address (TA) change at each hop of the multi-hop relay path, and a relay device immediately upstream of the edge client determines a final RA in accordance with the AID.

Clause 65: The method of any of clauses 63-64, wherein the AID is included in an A-Control field of the one or more data frames.

Clause 66: A method for wireless communication performable at a first wireless communication device, comprising: obtaining, based at least in part on coordination with first timing information pertaining to first communication periods that correspond to a set of access points (APs), one or more management frames indicating at least second timing information pertaining to second communication periods that correspond to the second wireless communication device, the one or more management frames distinguishing the second communication periods from the first communication periods in accordance with a configured set of identifiers (IDs) that correspond to the first communication periods and the second communication periods; and communicating with the second wireless communication device or a third wireless communication device in accordance with the second communication periods.

Clause 67: The method of clause 66, further comprising: obtaining the first timing information pertaining to the first communication periods, wherein the set of APs to which the first communication periods correspond are overlapping basic service set (OBSS) APs; and respecting a set of rules associated with the first communication periods.

Clause 68: The method of clause 67, wherein respecting the first communication periods comprises: terminating a transmission opportunity of the first wireless communication period prior to a start of each of the first communication periods; and following a set of channel access rules within each of the first communication periods.

Clause 69: The method of any of clauses 66-68, further comprising: obtaining the first timing information within a first set of fields of a first information element of the one or more management frames, wherein each respective first ID field associated with the first set of fields includes a same ID of the configured set of IDs; and obtaining the second timing information within a second set of fields of the first information element of the one or more management frames, wherein each respective second ID field associated with the second set of fields includes a unique ID of the configured set of IDs.

Clause 70: The method of clause 69, wherein each respective first ID field associated with the first set of fields includes the same ID of the configured set of IDs to distinguish the first communication periods as corresponding to one or more overlapping basic service sets (OBSSs), and unique IDs for each respective second ID field associated with the second set of fields differentiates the second communication periods into one or more schedules of communication periods of the second wireless communication device.

Clause 71: The method of any of clauses 66-70, further comprising: obtaining a first subset of the first timing information within a first set of fields of a first information element of the one or more management frames; obtaining the second timing information within a second set of fields of the first information element of the one or more management frames; and obtaining a second subset of the first timing information within a third set of fields of a second information element of the one or more management frames.

Clause 72: The method of clause 71, wherein the first subset of the first timing information pertains to a first subset of the first communication periods, the first subset of the first communication periods corresponding to a first set of APs associated with the second wireless communication device, and the second subset of the first timing information pertains to a second subset of the first communication periods, the second subset of the first communication periods corresponding to a second set of APs non-collocated with the second wireless communication device.

Clause 73: The method of any of clauses 71-72, wherein each respective first ID field associated with the first set of fields and the second set of fields includes a unique ID of the configured set of IDs, and each respective second ID field associated with the third set of fields includes a respective identification information corresponding to a respective AP of a second set of APs non-collocated with the second wireless communication device.

Clause 74: The method of clause 73, wherein the second information element is an extension element, and the respective identification information comprises respective basic service set (BSS) ID identifying information.

Clause 75: The method of any of clauses 66-74, further comprising: obtaining the first timing information within a first set of fields of the one or more management frames, wherein a respective first schedule information subfield value of each of the first set of fields is set to a same value in accordance with the first communication periods corresponding to the set of APs, the set of APs belonging to a same co-hosted basic service set (BSS) ID set as the second wireless communication device; and obtaining the second timing information within a second set of fields of the one or more management frames, wherein a respective second schedule information subfield value of each of the second set of fields is set to a value from a set of multiple values in accordance with the second communication periods corresponding to the second wireless communication device.

Clause 76: The method of clause 75, wherein the respective first schedule information subfield value is a dedicated value of a schedule information field that indicates that a corresponding schedule of communication periods is for one of the set of APs associated with the second wireless communication device, and the set of multiple values is a set of values of the schedule information field that indicates that a corresponding schedule of communication periods is for the second wireless communication device.

Clause 77: The method of any of clauses 66-76, further comprising: obtaining exclusively the second timing information within a set of fields of the one or more management frames, wherein a respective schedule information subfield value of each of the set of fields is set to a value from a set of multiple values in accordance with the second communication periods corresponding to the second wireless communication device.

Clause 78: The method of clause 77, wherein the set of multiple values is a set of values of a schedule information field that indicates that a corresponding schedule of communication periods is for the second wireless communication device.

Clause 79: The method of any of clauses 66-78, further comprising: obtaining the first timing information within a first set of fields of a first information element of the one or more management frames, the first information element being outside of a multiple basic service set (BSS) ID information element; obtaining the second timing information within a second set of fields of the first information element of the one or more management frames; and obtaining respective subsets of the first timing information within respective fields of respective non-transmitted BSSID sub-elements of the multiple BSSID information element.

Clause 80: The method of clause 79, wherein a respective first schedule information subfield value of each of the first set of fields is set to a same value in accordance with the first communication periods corresponding to the set of APs, and a respective schedule information subfield value of each of the second set of fields is set to a value from a set of multiple values in accordance with the second communication periods corresponding to the second wireless communication device.

Clause 81: The method of any of clauses 79-80, wherein each respective non-transmitted BSSID sub-element of the multiple BSSID information element includes a respective subset of the first timing information and excludes a remainder of the first timing information, and a schedule information subfield of that respective non-transmitted BSSID sub-element is set to a value from a set of multiple values.

Clause 82: The method of any of clauses 79-81, wherein the first wireless communication device parses the first information element and ignores the multiple BSSID information element in accordance with the first wireless communication device being associated with the second wireless communication device, the second wireless communication device being associated with a transmitted BSSID.

Clause 83: The method of any of clauses 79-82, wherein the first wireless communication device parses the first information element and parses a non-transmitted BSSID sub-element of the multiple BSSID information element corresponding to an AP of the set of APs in accordance with the first wireless communication device being associated with the AP, the AP being associated with a non-transmitted BSSID.

Clause 84: The method of any of clauses 66-83, further comprising: obtaining the second timing information within a first set of fields of a first information element of the one or more management frames, the first information element being outside of a multiple basic service set (BSS) ID information element; and obtaining respective subsets of the first timing information within respective fields of respective non-transmitted BSSID sub-elements of the multiple BSSID information element.

Clause 85: The method of clause 84, wherein a respective schedule information subfield value of each of the first set of fields is set to a value from a set of multiple values in accordance with the second communication periods corresponding to the second wireless communication device.

Clause 86: The method of any of clauses 84-85, wherein each respective non-transmitted BSSID sub-element of the multiple BSSID information element includes a respective subset of the first timing information and excludes a remainder of the first timing information, and a schedule information subfield of that respective non-transmitted BSSID sub-element is set to a value from a set of multiple values.

Clause 87: The method of any of clauses 84-86, wherein the first wireless communication device parses the first information element and parses each respective non-transmitted BSSID sub-element of the multiple BSSID information element in accordance with the first wireless communication device being associated with any AP of a multiple BSSID set associated with the multiple BSSID information element.

Clause 88: The method of any of clauses 66-87, further comprising: obtaining the first timing information within a first set of fields of a first information element of the one or more management frames, the first information element being outside of a multiple basic service set (BSS) ID information element; obtaining the second timing information within a second set of fields of the first information element of the one or more management frames; and obtaining both the first timing information and the second timing information within a third set of one or more fields of each non-transmitted BSSID sub-element of the multiple BSSID information element.

Clause 89: The method of clause 88, wherein a respective first schedule information subfield value of each of the first set of fields is set to a same value in accordance with the first communication periods corresponding to the set of APs, and a respective schedule information subfield value of each of the second set of fields is set to a value from a set of multiple values in accordance with the second communication periods corresponding to the second wireless communication device.

Clause 90: The method of any of clauses 88-89, wherein each respective non-transmitted BSSID sub-element of the multiple BSSID information element includes a first field including a subset of the first timing information of a corresponding non-transmitted BSSID and includes one or more second fields including a remainder of the first timing information and the second timing information, and the first field includes a first schedule information subfield value set to a value from a set of multiple values and each of the one or more second fields include a second schedule information subfield value set to a same value.

Clause 91: The method of any of clauses 88-90, wherein the first wireless communication device parses the first information element and ignores the multiple BSSID information element in accordance with the first wireless communication device being associated with the second wireless communication device, the second wireless communication device being associated with a transmitted BSSID.

Clause 92: The method of any of clauses 88-91, wherein the first wireless communication device ignores the first information element and parses a non-transmitted BSSID sub-element of the multiple BSSID information element corresponding to an AP of the set of APs in accordance with the first wireless communication device being associated with the AP, the AP being associated with a non-transmitted BSSID.

Clause 93: The method of any of clauses 66-92, wherein the first communication periods are active schedules of communication periods that correspond to the set of APs.

Clause 94: The method of any of clauses 66-93, further comprising: obtaining one or more second management frames; and detecting a change to timing information of the first timing information or the second timing information or to one or more states associated with the first communication periods or the second communication periods based at least in part on a field value in the one or more second management frames.

Clause 95: The method of clause 94, wherein the field value is associated with a critical update flag having a one value, an increment to a basic service set (BSS) parameter change count, or an increment to a value associated with a check beacon field value.

Clause 96: The method of any of clauses 94-95, wherein the field value is dedicated to changes related to protected communication.

Clause 97: The method of any of clauses 94-96, wherein a change to a state is associated with a change of a schedule of communication periods from active to inactive, inactive to active, open to new members to closed to new members, or closed to new members to open to new members.

Clause 98: The method of any of clauses 66-97, further comprising: accessing a wireless channel during a communication period of the second communication periods based at least in part on prioritized access for the first wireless communication device during the second communication periods.

Clause 99: The method of clause 98, wherein the prioritized access for the first wireless communication device is associated with one or more quiet intervals to other wireless communication devices or a relatively smaller channel access countdown value as compared to the other wireless communication devices.

Clause 100: The method of any of clauses 66-99, further comprising: obtaining the first timing information or the second timing information within an information element outside of a target wake time (TWT) information element.

Clause 101: The method of clause 100, wherein the information element outside of the TWT information element is included in a management frame that follows a beacon frame, and the beacon frame indicates that the first timing information or the second timing information is included in the information element included in the management frame that follows the beacon frame.

Clause 102: The method of clause 101, wherein the beacon frame includes the second timing information and a first subset of the first timing information that pertains to a first set of APs associated with the second wireless communication device and the management frame that follows the beacon frame includes a second subset of the first timing information that pertains to a second set of APs non-collocated with the second wireless communication device, and the one or more management frames include the beacon frame and the management frame that follows the beacon frame.

Clause 103: The method of any of clauses 66-102, wherein the first timing information or the second timing information are expressed on a basis of milliseconds that do not divide evenly into time units (TUs), and the first timing information or the second timing information indicate start times of initial communication periods of the first communication periods or the second communication periods based at least in part on the first timing information or the second timing information being expressed on the basis of the milliseconds that do not divide evenly into TUs.

Clause 104: The method of any of clauses 66-103, wherein the first timing information or the second timing information are expressed on a basis of time units (TUs), and the first timing information or the second timing information indicate start times of next communication periods of the first communication periods or the second communication periods based at least in part on the first timing information or the second timing information being expressed on the basis of TUs.

Clause 105: The method of any of clauses 66-104, further comprising: transmitting a request to join a schedule of communication periods of the second communication periods; and obtaining an indication of an alternative schedule of communication periods of the second communication periods.

Clause 106: The method of clause 105, wherein a device capability of the first wireless communication device is associated with an inability to differentiate between restricted target wake time (R-TWT) parameter sets and broadcast target wake time (b-TWT) parameter sets, and the indication of the alternative schedule of communication periods is obtained based at least in part on the device capability.

Clause 107: The method of any of clauses 66-106, wherein the first communication periods and the second communication periods are associated with any combination of one or more restricted target wake time (R-TWT) service periods (SPs), one or more TWT epochs, one or more quiet intervals, selective transmission opportunity (TXOP) sharing, or one or more differentiated channel access parameters that prioritize channel access to at least one wireless communication device.

Clause 108: The method of any of clauses 66-107, wherein the first wireless communication device is a wireless STA and the second wireless communication device is an AP.

Clause 109: The method of clause 108, wherein the set of APs includes a first set of APs associated with the first wireless communication device, a second set of APs non-collocated with the first wireless communication device, or any combination thereof, and the AP and the first set of APs are members of a same multiple basic service set (BSS) ID set or a same co-hosted BSSID set.

Clause 110: The method of any of clauses 66-109, wherein the first communication periods are first protected communication periods associated with first restricted target wake times (R-TWTs), and the second communication periods are second protected communication periods associated with second R-TWTs.

Clause 111: A first wireless communication device, comprising at least one memory; and at least one processor communicatively coupled with the at least one memory, the at least one processor operable to cause the first wireless communication device to perform a method of any of clauses 1-54.

Clause 112: A first wireless communication device, comprising a processing system that includes one or more processors and one or more memories coupled with the one or more processors, the processing system configured to cause the first wireless communication device to perform a method of any of clauses 1-54.

Clause 113: A first wireless communication device, comprising at least one means for performing a method of any of clauses 1-54.

Clause 114: A non-transitory computer-readable medium storing code for wireless communication performable at a first wireless communication device, the code comprising instructions executable by one or more processors to perform a method of any of clauses 1-54.

Clause 115: A first wireless communication device, comprising at least one memory; and at least one processor communicatively coupled with the at least one memory, the at least one processor operable to cause the first wireless communication device to perform a method of any of clauses 55-62.

Clause 116: A first wireless communication device, comprising a processing system that includes one or more processors and one or more memories coupled with the one or more processors, the processing system configured to cause the first wireless communication device to perform a method of any of clauses 55-62.

Clause 117: A first wireless communication device, comprising at least one means for performing a method of any of clauses 55-62.

Clause 118: A non-transitory computer-readable medium storing code for wireless communication performable at a first wireless communication device, the code comprising instructions executable by one or more processors to perform a method of any of clauses 55-62.

Clause 119: A first wireless communication device, comprising at least one memory; and at least one processor communicatively coupled with the at least one memory, the at least one processor operable to cause the first wireless communication device to perform a method of any of clauses 63-65.

Clause 120: A first wireless communication device, comprising a processing system that includes one or more processors and one or more memories coupled with the one or more processors, the processing system configured to cause the first wireless communication device to perform a method of any of clauses 63-65.

Clause 121: A first wireless communication device, comprising at least one means for performing a method of any of clauses 63-65.

Clause 122: A non-transitory computer-readable medium storing code for wireless communication performable at a first wireless communication device, the code comprising instructions executable by one or more processors to perform a method of any of clauses 63-65.

Clause 123: A first wireless communication device, comprising at least one memory; and at least one processor communicatively coupled with the at least one memory, the at least one processor operable to cause the first wireless communication device to perform a method of any of clauses 66-110.

Clause 124: A first wireless communication device, comprising a processing system that includes one or more processors and one or more memories coupled with the one or more processors, the processing system configured to cause the first wireless communication device to perform a method of any of clauses 66-110.

Clause 125: A first wireless communication device, comprising at least one means for performing a method of any of clauses 66-110.

Clause 126: A non-transitory computer-readable medium storing code for wireless communication performable at a first wireless communication device, the code comprising instructions executable by one or more processors to perform a method of any of clauses 66-110.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes one or more processors and one or more memories coupled with the one or more processors, the processing system configured to cause the first wireless communication device to:
transmit one or more management frames indicating first timing information and second timing information, the first timing information pertaining to first communication periods that correspond to a set of access points (APs), and the second timing information pertaining to second communication periods that correspond to the first wireless communication device, the one or more management frames distinguishing the second communication periods from the first communication periods in accordance with a configured set of identifiers (IDs) that correspond to the first communication periods and the second communication periods; and
communicate with one or more wireless stations (STAs) associated with the first wireless communication device during at least a subset of the second communication periods.

2. The first wireless communication device of claim 1, wherein the processing system is further configured to cause the first wireless communication device to:
transmit the first timing information within a first set of fields of a first element of the one or more management frames, the first element being outside of a multiple basic service set (BSS) ID (BSSID) element of the one or more management frames;
transmit the second timing information within a second set of fields of the first element of the one or more management frames; and
transmit respective subsets of the first timing information within respective fields of respective nontransmitted BSSID profiles of the multiple BSSID element.

3. The first wireless communication device of claim 2, wherein:
a respective first schedule information subfield value of each of the first set of fields is set to a same value in accordance with the first communication periods matching to a corresponding AP in the set of APs; and
a respective second schedule information subfield value of each of the second set of fields is set to a value from a set of multiple values in accordance with the second communication periods corresponding to the first wireless communication device.

4. The first wireless communication device of claim 3, wherein:
the same value is a restricted target wake time (TWT) schedule information (RTSI) subfield value of 3; and
the set of multiple values includes RTSI subfield values of 0, 1, and 2.

5. The first wireless communication device of claim 2, wherein:
each respective nontransmitted BSSID profile of the multiple BSSID element includes a respective subset of the first timing information and excludes a remainder of the first timing information; and
a schedule information subfield of a target wake time (TWT) element of that respective nontransmitted BSSID profile is set to a value from a set of multiple values.

6. The first wireless communication device of claim 5, wherein the set of multiple values includes restricted target wake time (TWT) schedule information (RTSI) subfield values of 0, 1, and 2.

7. The first wireless communication device of claim 5, wherein a broadcast target wake time (TWT) ID subfield of the TWT element of that respective nontransmitted BSSID profile is set to an ID of a subset of the configured set of IDs.

8. The first wireless communication device of claim 7, wherein the subset of the configured set of IDs includes broadcast TWT ID subfield values within a range greater than 0 and less than 31.

9. The first wireless communication device of claim 2, wherein:
the first set of fields includes one or more first broadcast target wake time (TWT) ID subfields, each field of the first set of fields including a respective first broadcast TWT ID subfield of the one or more first broadcast TWT ID subfields, and the one or more first broadcast TWT ID subfields being set to a same ID of the configured set of IDs; and
the second set of fields includes one or more second broadcast TWT ID subfields, each field of the second set of fields including a respective second broadcast TWT ID subfield of the one or more second broadcast TWT ID subfields, and each second broadcast TWT ID subfield of the one or more second broadcast TWT ID subfields including a respective ID of a subset of the configured set of IDs.

10. The first wireless communication device of claim 9, wherein:
the one or more first broadcast TWT ID subfields include the same ID of the configured set of IDs to distinguish the first communication periods as corresponding to one or more nontransmitted basic service set (BSS) IDs (BSSIDs) in a same multiple BSSID set or a same co-hosted BSSID set as the first wireless communication device; and
the one or more second broadcast TWT ID subfields include unique IDs of the subset of the configured set of IDs to differentiate the second communication periods into one or more schedules of communication periods of the first wireless communication device.

11. The first wireless communication device of claim 9, wherein:
the same ID is a broadcast TWT ID subfield value of 31; and
the subset of the configured set of IDs includes broadcast TWT ID subfield values within a range greater than 0 and less than 31.

12. The first wireless communication device of claim 1, wherein the processing system is further configured to cause the first wireless communication device to:
transmit the first timing information within a first set of fields of the one or more management frames, wherein each respective first ID field associated with the first set of fields includes a same ID of the configured set of IDs in accordance with the first communication periods corresponding to the set of APs, the set of APs belonging to a same multiple basic service set (BSS) ID (BSSID) set or a same co-hosted set as the first wireless communication device; and
transmit the second timing information within a second set of fields of the one or more management frames, wherein each respective second ID field associated with the second set of fields includes a unique ID of a subset of the configured set of IDs in accordance with the second communication periods corresponding to the first wireless communication device.

13. The first wireless communication device of claim 12, wherein:
the first wireless communication device is a restricted target wake time (TWT) (R-TWT) scheduling AP that is announcing an R-TWT schedule with a restricted TWT schedule information (RTSI) subfield value set to 3; and
the R-TWT scheduling AP sets a broadcast TWT ID subfield to a fixed value of 31 in a broadcast TWT field corresponding to the R-TWT schedule in accordance with announcing the R-TWT schedule with the RTSI subfield set to 3.

14. The first wireless communication device of claim 13, wherein:
the R-TWT schedule is indicated by the first timing information; and
the same ID of the configured set of IDs is equal to the fixed value of 31.

15. The first wireless communication device of claim 12, wherein the first set of fields and the second set of fields are outside of a multiple BSSID element of the one or more management frames.

16. The first wireless communication device of claim 1, wherein the processing system is further configured to cause the first wireless communication device to:
transmit the first timing information within a first set of fields of the one or more management frames, wherein a respective first schedule information subfield value of each of the first set of fields is set to a same value in accordance with the first communication periods corresponding to the set of APs, the set of APs belonging to a same multiple basic service set (BSS) ID (BSSID) set or a same co-hosted set as the first wireless communication device; and
transmit the second timing information within a second set of fields of the one or more management frames, wherein a respective second schedule information subfield value of each of the second set of fields is set to a value from a set of multiple values in accordance with the second communication periods corresponding to the first wireless communication device.

17. The first wireless communication device of claim 16, wherein the same value is a restricted target wake time (TWT) schedule information (RTSI) subfield value of 3, and wherein a broadcast TWT ID subfield of each of the first set of fields is set to a value of 31 in accordance with the RTSI subfield value of 3.

18. The first wireless communication device of claim 16, wherein the first set of fields and the second set of fields are outside of a multiple BSSID element of the one or more management frames.

19. The first wireless communication device of claim 1, wherein the processing system is further configured to cause the first wireless communication device to:
change timing information of the first timing information or the second timing information or one or more states associated with the first communication periods or the second communication periods;
set a field value in one or more second management frames based at least in part on changing the timing information or the one or more states, wherein setting the field value is associated with setting a critical update flag to a one value, incrementing a basic service set (BSS) parameter change count, or incrementing a value associated with a check beacon field value; and
transmit the one or more second management frames in accordance with the field value.

20. The first wireless communication device of claim 1, wherein the processing system is further configured to cause the first wireless communication device to:
schedule the second communication periods based at least in part on the first communication periods and one or more periodic transmissions by the first wireless communication device, wherein target beacon transmission times (TBTTs) corresponding to the first wireless communication device are during the second communication periods, the one or more periodic transmissions including periodic beacon transmissions associated with the TBTTs.

21. The first wireless communication device of claim 1, wherein the first communication periods and the second communication periods are associated with any combination of one or more restricted target wake time (R-TWT) service periods (SPs), one or more TWT epochs, one or more quiet intervals, selective transmission opportunity (TXOP) sharing, or one or more differentiated channel access parameters that prioritize channel access to at least one wireless communication device.

22. The first wireless communication device of claim 1, wherein:
the first wireless communication device is an AP; and
the set of APs includes a first set of APs associated with the first wireless communication device, a second set of APs non-collocated with the first wireless communication device, or any combination thereof.

23. The first wireless communication device of claim 1, wherein the first wireless communication device and the set of APs are members of a same multiple basic service set (BSS) ID (BSSID) set or a same co-hosted BSSID set.

24. The first wireless communication device of claim 1, wherein:
the first communication periods are first protected communication periods associated with first restricted target wake times (R-TWTs); and
the second communication periods are second protected communication periods associated with second R-TWTs.

25. The first wireless communication device of claim 1, wherein:
the first timing information pertaining to the first communication periods indicates a plurality of communication schedules, each respective AP of the set of APs corresponding to a respective set of one or more communication schedules of the plurality of communication schedules; and
the second timing information pertaining to the second communication periods indicates one or more communication schedules that correspond to the first wireless communication device.

26. A first wireless communication device, comprising:
a processing system that includes one or more processors and one or more memories coupled with the one or more processors, the processing system configured to cause the first wireless communication device to:
obtain one or more management frames indicating first timing information and second timing information, the first timing information pertaining to first communication periods that correspond to a set of access points (APs), and the second timing information pertaining to second communication periods that correspond to a second wireless communication device, the one or more management frames distinguishing the second communication periods from the first communication periods in accordance with a configured set of identifiers (IDs) that correspond to the first communication periods and the second communication periods; and
communicate with the second wireless communication device or a third wireless communication device in accordance with the second communication periods.

27. The first wireless communication device of claim 26, wherein the processing system is further configured to cause the first wireless communication device to:
respect a set of rules associated with the first communication periods, wherein the set of APs to which the first communication periods correspond are associated with one or more basic service set (BSS) IDs (BSSIDs) in a same multiple BSSID set or a same co-hosted set as the second wireless communication device.

28. The first wireless communication device of claim 27, wherein, to respect the first communication periods, the processing system is further configured to cause the first wireless communication device to:
terminate a transmission opportunity of the first wireless communication device prior to a start of each of the first communication periods; and
follow a set of channel access rules within each of the first communication periods.

29. The first wireless communication device of claim 26, wherein the processing system is further configured to cause the first wireless communication device to:
obtain the first timing information within a first set of fields of a first element of the one or more management frames, the first element being outside of a multiple basic service set (BSS) ID (BSSID) element of the one or more management frames;
obtain the second timing information within a second set of fields of the first element of the one or more management frames; and
obtain respective subsets of the first timing information within respective fields of respective nontransmitted BSSID profiles of the multiple BSSID element.

30. The first wireless communication device of claim 29, wherein the first wireless communication device parses the first element and ignores the multiple BSSID element in accordance with the first wireless communication device being associated with the second wireless communication device, the second wireless communication device being associated with a transmitted BSSID.

31. The first wireless communication device of claim 29, wherein the first wireless communication device parses the first element and parses a nontransmitted BSSID profile of the multiple BSSID element corresponding to an AP of the set of APs in accordance with the first wireless communication device being associated with the AP, the AP being associated with a nontransmitted BSSID.

32. The first wireless communication device of claim 29, wherein the first wireless communication device parses the first element and parses a nontransmitted BSSID profile of the multiple BSSID element, and wherein the processing system is further configured to cause the first wireless communication device to:
inherit information conveyed via the first element if a second element having a same ID as the first element is not included in the nontransmitted BSSID profile, the information that is inherited only including the second set of fields having broadcast target wake time (TWT) ID subfield values within a range greater than 0 and less than 31.

33. A method for wireless communication by a first wireless communication device, comprising:
transmitting one or more management frames indicating first timing information and second timing information, the first timing information pertaining to first communication periods that correspond to a set of access points (APs), and the second timing information pertaining to second communication periods that correspond to the first wireless communication device, the one or more management frames distinguishing the second communication periods from the first communication periods in accordance with a configured set of identifiers (IDs) that correspond to the first communication periods and the second communication periods; and
communicating with one or more wireless stations (STAs) associated with the first wireless communication device during at least a subset of the second communication periods.

34. A method for wireless communication by a first wireless communication device, comprising:
obtaining one or more management frames indicating first timing information and second timing information, the first timing information pertaining to first communication periods that correspond to a set of access points (APs), and the second timing information pertaining to second communication periods that correspond to a second wireless communication device, the one or more management frames distinguishing the second communication periods from the first communication periods in accordance with a configured set of identifiers (IDs) that correspond to the first communication periods and the second communication periods; and
communicating with the second wireless communication device or a third wireless communication device in accordance with the second communication periods.
